(19) United States
(12) Patent Application Publication
(10) Pub. No.: US 2014/0089962 A1
(43) Pub. Date: Mar. 27, 2014

(54) IMAGE PLAYBACK DEVICE, IMAGE PLAYBACK METHOD, IMAGE PLAYBACK PROGRAM, IMAGE TRANSMISSION DEVICE, IMAGE TRANSMISSION METHOD AND IMAGE TRANSMISSION PROGRAM

(71) Applicant: Panasonic Corporation, Osaka (JP)

(72) Inventors: Tomoki Ogawa, Osaka (JP); Hiroshi Yahata, Osaka (JP)

(21) Appl. No.: 14/118,679

(22) PCT Filed: Dec. 28, 2012
(86) PCT No.: PCT/JP2012/008445

§ 371 Date: Nov. 19, 2013

Related U.S. Application Data
(60) Provisional application No. 61/580,765, filed on Dec. 28, 2011.

(51) Int. Cl. H04N 21/4627; H04N 21/458; H04N 13/00

(52) U.S. Cl. CPC H04N 21/4627; H04N 13/0059; H04N 21/458
USPC 725/29

(57) ABSTRACT

Video playback device for performing realtime playback of 3D video by playing back first view-point video and second view-point video in combination, first view-point video being received via broadcasting in real time over broadcast waves, second view-point video being stored in advance before broadcasting of first view-point video, video playback device comprising: storage storing second view-point video; video receiving unit receiving first view-point video; information obtaining unit obtaining inhibition/permission information that indicates, for each video frame, whether displaying video frame before current time reaches scheduled presentation time is inhibited or permitted, scheduled presentation time being time at which video frame is scheduled to be broadcast for realtime playback; playback unit playing back second view-point video; and control unit inhibiting second view-point video from being played back when scheduled presentation time of next video frame is later than current time and inhibition/permission information indicates that displaying next video frame is inhibited.

### TECHNICAL FIELD

The present invention relates to hybrid 3D broadcast in which left-eye and right-eye videos constituting 3D video are transmitted separately by using broadcast and communication.

### BACKGROUND ART

In recent years, the hybrid service between broadcast and communication has been studied by the broadcasting organizations and the like. As one example of the technology for providing the hybrid service, Non-Patent Literature 1 discloses “Hybridcast™” in which a playback device receives a broadcast program via broadcast waves and a content via a network and presents them in combination and synchronization with each other.

### CITATION LIST

### Non-Patent Literature

Non-Patent Literature 1: Kinji Matsumura and Yasuaki Kanatsugu, “Hybridcast™” System and Technology Overview,” NHK STRL R&D, No. 124, 2010

### SUMMARY OF INVENTION

### Technical Problem

Meanwhile, the above-described technology makes it possible for a transmission device (a broadcasting station) to transmit, namely broadcast, a left-eye video in real time, and transmit a right-eye video in advance via a network at the timing when, for example, the load on the network is small so that the playback device can store it in advance before the broadcasting of the left-eye video, in the case where a 3D video is composed of the left-eye video and the right-eye video. This structure allows for the playback device to play back, in combination, the left-eye video that is broadcast in real time and the right-eye video stored in advance. With this structure, the playback device will be able to play back the 3D video in real time in the same manner as when both the left-eye video and the right-eye video are broadcast in real time.

However, when the playback device is allowed to store the right-eye video in advance, it becomes possible for the viewer to play back some of the video frames constituting the right-eye video before the scheduled presentation time indicated by the PTS (Presentation Time Stamp) comes (hereinafter such a playback is referred to as “passing playback”), by performing, for example, a trick play like fast forward or high-speed playback on the right-eye video.

In that case, the viewer can view some images before the scheduled time, which is not possible in general cases where the 3D video is received via broadcast waves and played back in real time. This could be a disadvantage for, for example, a broadcasting organization who decides a scheduled broadcast time of a CM (Commercial Message) video that informs the viewers of a sale to be held for a predetermined period because such a CM video is expected to have an effect when it is broadcast at an appropriate time, not when it is broadcast before the scheduled broadcast time.

It is therefore an object of the present invention to provide a video playback device and a video transmission device that can protect profits of broadcasting organizations or the like by controlling whether to permit the passing playback for viewers to view video images stored in advance.

### Solution to Problem

The above object is fulfilled by a video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback device comprising: a storage storing the second view-point video; a video receiving unit configured to receive the first view-point video over the broadcast waves; an information obtaining unit configured to obtain inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback; a playback unit configured to play back the second view-point video; and a control unit configured to inhibit the second view-point video from being played back when the scheduled presentation time of a next video frame, which is a video frame to be displayed next, is later than current time and the inhibition/permission information indicates that displaying the next video frame is inhibited.

### Advantageous Effects of Invention

With the above-described structure, the video playback device of the present invention can control appropriately whether to permit a playback of a video frame, which is stored in advance, before current time reaches a scheduled presentation time that is a time at which the video frame is scheduled to be broadcast for the realtime playback.

### BRIEF DESCRIPTION OF DRAWINGS

FIG. 1 is a schematic diagram illustrating one example of generating parallax images of left-eye and right-eye images from a 2D video and a depth map.

FIG. 2A illustrates the use form of a 3D digital TV; FIG. 2B illustrates the state of the 3D glasses when a left-eye video image is displayed; and FIG. 2C illustrates the state of the 3D glasses when a right-eye video image is displayed.

FIG. 3 illustrates the structure of a digital stream in the MPEG-2 TS format.

FIG. 4 illustrates the data structure of the PMT.

FIG. 5A illustrates one example of GOP; and FIG. 5B illustrates the internal structure of the video access unit that is the I-picture at the head of the GOP.

FIG. 6 is a diagram illustrating the process of converting pictures into PES packets.

FIG. 7A illustrates the data structure of the TS packet; and FIG. 7B illustrates the data structure of the TS header.

FIG. 8 illustrates a parallax image in detail.

FIG. 9 illustrates the Side-by-Side method.

FIG. 10 illustrates an example of the internal structure of a left-view video stream and a right-view video stream.

FIG. 11 illustrates the structure of the video access unit.

FIG. 12 illustrates an example of the relationship between PTS and DTS allocated to each video access unit.

FIG. 13 illustrates the GOP structure of the base-view video stream and the dependent-view video stream.

FIG. 14A illustrate the structure of a video access unit placed at the head of the dependent GOP; and FIG. 14B illustrate the structure of a video access unit placed at other than the head of the dependent GOP.

FIG. 15 illustrates the structure of a video transmission/reception system in one embodiment of the present invention.

FIG. 16 is a block diagram illustrating a functional structure of the transmission device.

FIG. 17 illustrates the data structure of the passing playback control descriptor.

FIG. 18 is a block diagram illustrating the functional structure of the playback device.

FIG. 19 is a flowchart of the video transmission process.

FIG. 20 is a flowchart of the video playback process.

FIG. 21 is a flowchart of the trick play process using the stored video.

FIG. 22 is a diagram illustrating the data structure of a PTS difference descriptor in one modification.

FIG. 23 is a diagram illustrating the data structure of a 3D playback limitation descriptor in one modification.

FIG. 24 is a block diagram illustrating a functional structure of the playback device in one modification.

### DESCRIPTION OF EMBODIMENTS

### 1. Embodiment 1

The following describes an embodiment of the present invention with reference to the attached drawings.

### <1.1 Summary>

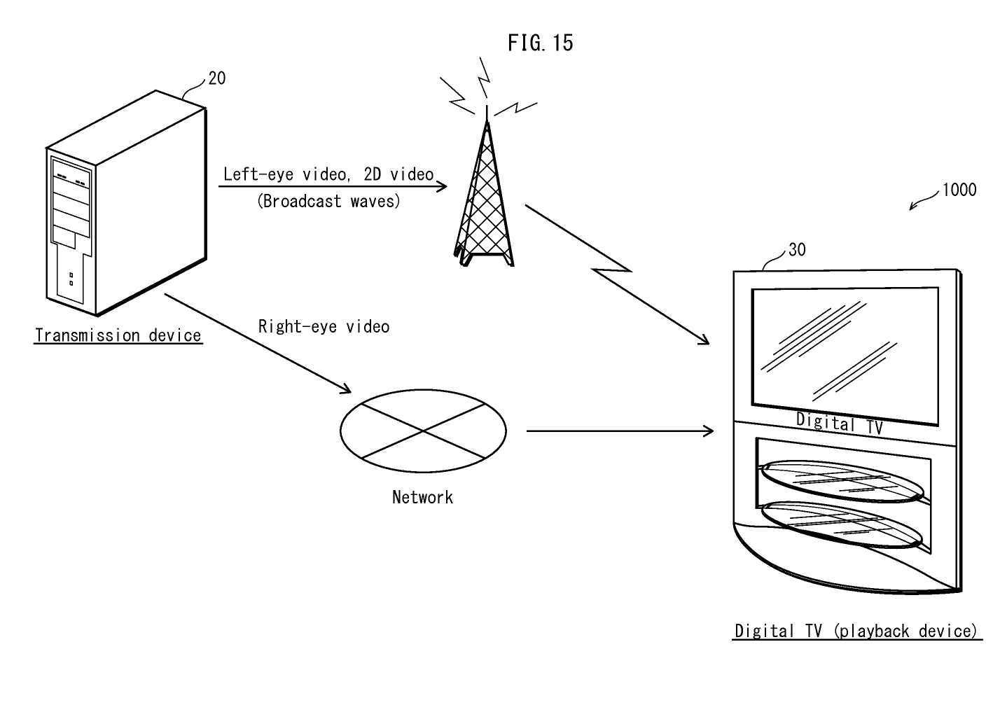

A video transmission/reception system 1000 in one embodiment of the present invention, as illustrated in FIG. 15, includes: a transmission device 20 as one example of a video transmission device for transmitting 3D video; and a playback device 30 as one example of a video playback device for receiving and playing back the 3D video.

The transmission device 20 generates a transport stream (hereinafter referred to as “TS”) by encoding a first view-point video (in the present embodiment, a left-eye video, as one example) and a second view-point video (in the present embodiment, a right-eye video, as one example), wherein the first and second view-point videos constitute the 3D video. The transmission device 20 broadcasts a TS that is generated by encoding the left-eye video (hereinafter referred to as “left-eye TS”), in real time by using broadcast waves.

On the other hand, the transmission device 20 transmits a TS that is generated by encoding the right-eye video (hereinafter referred to as “right-eye TS”), to the playback device 30 via a network before it broadcasts the left-eye TS in real time. The right-eye TS is received and stored by the playback device 30 before the left-eye TS is broadcast in real time over broadcast waves.

The playback device 30 plays back the 3D video by playing back the left-eye and right-eye videos at appropriate timing, namely by playing back the right-eye video that has been stored in advance, in synchronization with the left-eye video that is broadcast in real time (hereinafter this playback is referred to as “realtime 3D playback”).

In the following description, broadcasting a 3D video by using both broadcast waves and a network in combination is referred to as “hybrid 3D broadcast”. Also, a method of transmitting a certain video (in the present embodiment, the right-eye video), which is one of the videos constituting a 3D video, via an IP network in advance for the certain video to be stored before the realtime 3D playback performed over broadcast waves is referred to as “advance storage type 3D broadcast” or “advance download type 3D broadcast”.

Here, the advance storage type 3D broadcast allows for the passing playback to be performed by using the right-eye video that is stored in advance. For example, when a left-eye video received via broadcast waves has been broadcast for 30 minutes in real time during a realtime playback of a 3D video of a one-hour broadcast program, the playback device may play back a right-eye video that is scheduled to be broadcast 40 minutes after the start of the broadcast.

The videos broadcast by broadcasting organizations may include a video (for example, a CM video that informs the viewers of a sale to be held for a predetermined period) that is intended to be viewed during the realtime broadcast using broadcast waves, not at another timing since, if it is viewed at a timing other than the realtime broadcast, it would be a disadvantage for the broadcasting organization and impair profit of the broadcasting organization because the scheduled broadcast time is decided for the CM to have the largest effect when broadcast at the time. On the other hand, the videos broadcast by broadcasting organizations may include a video that does not cause a problem if it is played back by the passing playback.

In the video transmission/reception system 1000 in one embodiment of the present invention, the transmission device 20 transmits, to the playback device 30, information indicating whether or not a passing playback can be performed, and the playback device 30 plays back the video after making judgment on the passing playback in accordance with the information. With this structure, the video transmission/reception system 1000 protects profits of the broadcasting organizations.

The following describes the video transmission/reception system 1000 in more detail with reference to the attached drawings.

### <1.2. Structure>

The following describes the devices constituting the video transmission/reception system 1000 in more detail.

### <1.2.1. Transmission Device 20>

The transmission device 20 includes an information processing device such as a personal computer, a broadcast antenna, etc.

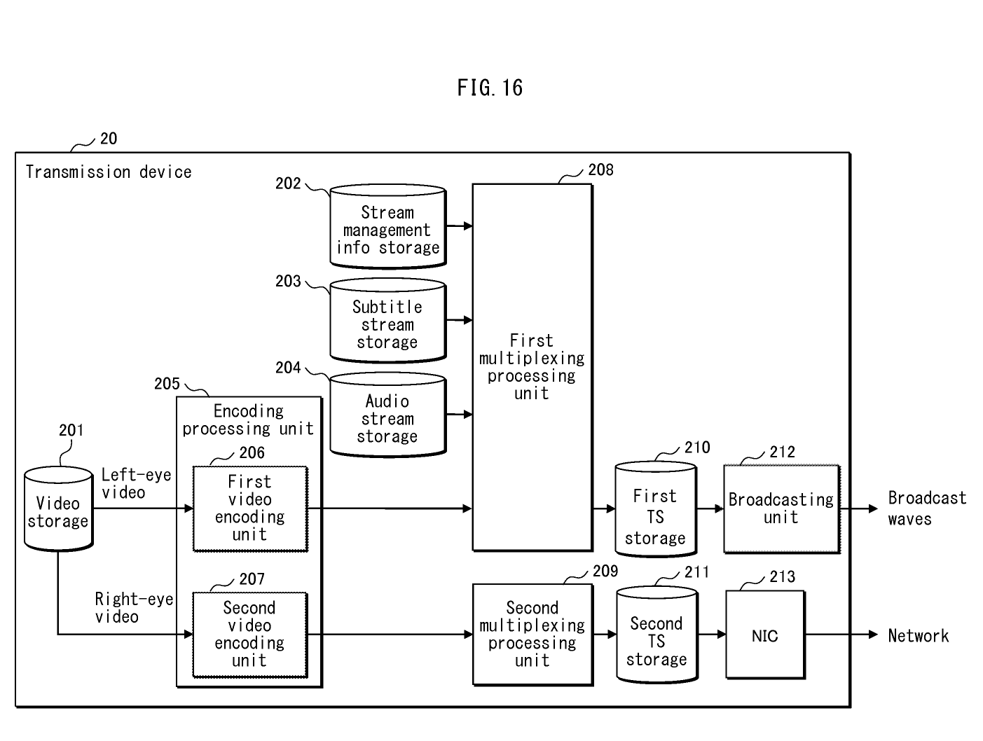

FIG. 16 illustrates a functional structure of the transmission device 20. As illustrated in FIG. 16, the transmission device 20 may include a video storage 201, a stream management information storage 202, a subtitle stream storage 203, an audio stream storage 204, an encoding processing unit 205, a first multiplexing processing unit 208, a second multiplexing processing unit 209, a first TS storage 210, a second TS storage 211, a broadcasting unit 212, and a NIC (Network Interface Card) 213.

The transmission device 20 further includes a processor and a memory, and the functions of the encoding processing unit 205, first multiplexing processing unit 208, second multiplexing processing unit 209, broadcasting unit 212, and NIC 213 are realized as the processor executes a program stored in the memory.

### <Video Storage 201>

The video storage 201 may be composed of a nonvolatile storage device. The video storage 201 stores a left-eye video and a right-eye video that constitute a 3D broadcast program, which is a broadcast target (transmission target).

### <Stream Management Information Storage 202>

The stream management information storage 202 may be composed of a nonvolatile storage device. The stream management information storage 202 stores SI/PSI that is transmitted together with the left-eye video, wherein SI stands for Service Information and PSI stands for Program Specific Information. In the SI/PSI, detailed information of a broadcasting station and a channel (service), and broadcast program detailed information and the like are described. For details of the SI/PSI, refer to “The Association of Radio Industries and Businesses (ARIB), STD-B10 version 4.9, revised Mar. 28, 2011 (hereinafter referred to as ‘ARIB STD-B10’)”.

In the present embodiment, a “passing playback control descriptor”, which is described below, is newly added to the descriptors in the EIT (Event Information Table).

Note that the right-eye video to be stored in advance is assumed to have been assigned a unique identifier. In addition, it is assumed that the identifier of the right-eye video is described in, for example, an EIT of a left-eye video that corresponds to the right-eye video and is to be broadcast in real time by using broadcast waves. The playback device 30 is assumed to reference the EIT of the left-eye video to identify the right-eye video that corresponds to the left-eye video to be broadcast in real time.

### <Subtitle Stream Storage 203>

The subtitle stream storage 203 may be composed of a nonvolatile storage device. The subtitle stream storage 203 stores subtitle data of a subtitle that is overlaid on the video during the playback. The subtitle data to be stored therein has been generated by encoding a subtitle by an encoding method such as MPEG-2.

### <Audio Stream Storage 204>

The audio stream storage 204 may be composed of a nonvolatile storage device. The audio stream storage 204 stores audio data that has been compress-encoded by an encoding method such as the linear PCM.

### <Encoding Processing Unit 205>

The encoding processing unit 205 may be composed of an AV signal encoding LSI, and includes a first video encoding unit 206 and a second video encoding unit 207.

The first video encoding unit 206 has a function to compress-encode the left-eye video stored in the video storage 201, by the MPEG-2 Video method. The first video encoding unit 206 reads the left-eye video from the video storage 201, compress-encodes it, and outputs the encoded left-eye video to the first multiplexing processing unit 208. Hereinafter, a video stream containing the encoded left-eye video that has been compress-encoded by the first video encoding unit 206 is referred to as “left-eye video stream”. Note that the process of compress-encoding video by the MPEG-2 Video method is well-known, and description thereof is omitted unless it is explicitly stated otherwise.

The second encoding unit 207 has a function to compress-encode the right-eye video stored in the video storage 201, by the MPEG-2 Video method. The second encoding unit 207 reads the right-eye video from the video storage 201, compress-encodes it, and outputs the encoded right-eye video to the second multiplexing processing unit 209. Hereinafter, a video stream containing the encoded right-eye video that has been compress-encoded by the second encoding unit 207 is referred to as “right-eye video stream”.

Note that, for the playback device 30 to be able to play back the 3D video by using the left-eye and right-eye videos, the first video encoding unit 206 and the second video encoding unit 207 operate cooperatively and, for each of the video frames constituting the left-eye video and the right-eye video, make the PTSs of a video frame in the left-eye video (hereinafter referred to as “left-eye video frame”) and a corresponding video frame in the right-eye video (hereinafter referred to as “right-eye video frame”) match each other, wherein the left-eye video frame and the corresponding right-eye video frame make a pair and represent a 3D image.

### <First Multiplexing Processing Unit 208>

The first multiplexing processing unit 208 may be composed of a multiplexer LSI. The first multiplexing processing unit 208 generates a transport stream (TS) in the MPEG-2 TS format by converting, into packets as necessary, the SI/PSI, subtitle data and compress-encoded audio data, which are stored in the stream management information storage 202, subtitle stream storage 203, and audio stream storage 204, and the left-eye video stream obtained from the first video encoding unit 206, and multiplexing the converted packets, and stores the generated TS into the first TS storage 210. Note that the TS generated by the first multiplexing processing unit 208 corresponds to the above-described left-eye TS.

### <Second Multiplexing Processing Unit 209>

The second multiplexing processing unit 209 may be composed of a multiplexer LSI. The second multiplexing processing unit 209 generates a transport stream (TS) in the MPEG-2 TS format by converting the video compress-encoded by the second video encoding unit 207 into packets as necessary and multiplexing the converted packets, and stores the generated TS into the second TS storage 211. Note that the TS generated by the second multiplexing processing unit 209 corresponds to the above-described right-eye TS.

### <First TS Storage 210>

The first TS storage 210 may be composed of a nonvolatile storage device. The first TS storage 210 stores the left-eye TS generated by the first multiplexing processing unit 208.

### <Second TS Storage 211>

The second TS storage 211 may be composed of a nonvolatile storage device. The second TS storage 211 stores the right-eye TS generated by the second multiplexing processing unit 209.

### <Broadcasting Unit 212>

The broadcasting unit 212 includes a transmission LSI for transmitting a stream over broadcast waves, an antenna for transmitting broadcast waves, and the like. The broadcasting unit 212 broadcasts the left-eye TS stored in the first TS storage 210 in real time by using digital broadcast waves for terrestrial digital broadcasting or the like.

### <NIC 213>

The NIC 213 may be composed of a communication LSI for performing data transmission/reception via the network. The NIC 213 receives a right-eye video transmission request. The NIC 213 reads a right-eye TS, which has been generated by compress-encoding the right-eye video requested by the received transmission request, from the second TS storage 211, and transmits the right-eye TS to the requester device (in the present embodiment, the playback device 30) via the network.

Note that the right-eye video is assumed to have been assigned an ID for identification. Note also that each transmission request is assumed to contain an ID of a right-eye video.

### <1.2.2. Data Structure>

The following describes the passing playback control descriptor that is one example of inhibition/permission information and is a descriptor newly included in the EIT.

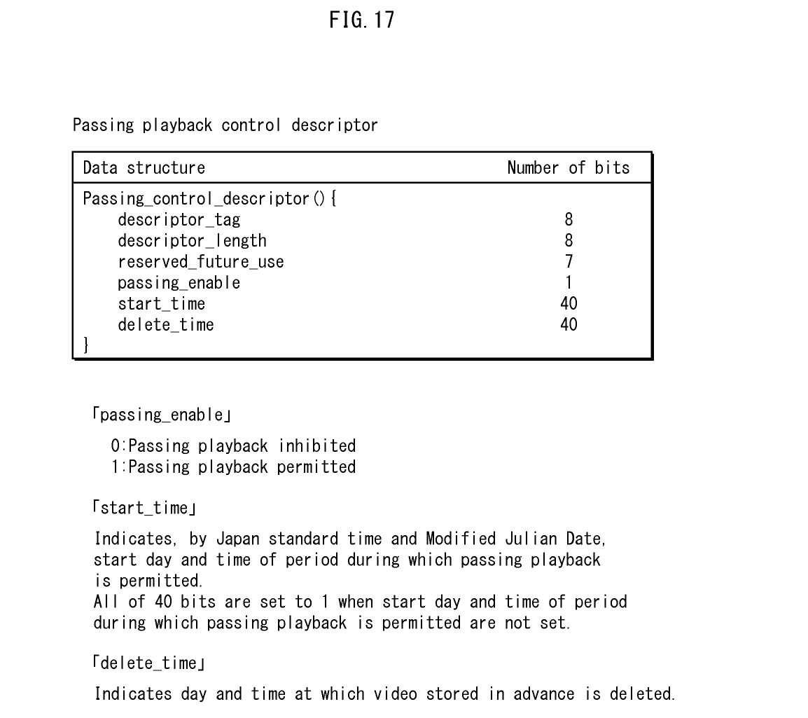

FIG. 17 illustrates the data structure of the passing playback control descriptor.

The passing playback control descriptor is a descriptor that indicates whether or not the passing playback can be performed.

The passing playback control descriptor includes descriptor_tag, descriptor_length, reserved_future_use, passing_enable, start_time, and delete_time.

Among these, the descriptor_tag, descriptor_length, and reserved_future_use are the same as those included in other descriptors. Furthermore, the start_time and delete_time are not used in the present embodiment, but used in the Modification. That is to say, in the present embodiment, the start_time and delete_time need not necessarily be included in the passing playback control descriptor.

The passing_enable indicates whether or not the passing playback of a video (in the present embodiment, the right-eye video) that has been stored in advance is permitted. The passing_enable set to 1 indicates that the passing playback is permitted, and the passing_enable set to 0 indicates that the passing playback is inhibited.

The broadcasting organization sets the passing_enable in the passing playback control descriptor to 0 for a video that the broadcasting organization does not want to be viewed before the scheduled broadcast time, such as a CM video whose scheduled broadcast time is decided with an expectation for the CM video to have an effect when it is broadcast at that time, and transmits the EIT with the descriptor described therein. On the other hand, the broadcasting organization sets the passing_enable in the passing playback control descriptor to 1 for a video that may be viewed before the scheduled broadcast time, and transmits the EIT with the descriptor described therein. This structure enables the broadcasting organization to control the permission/inhibition of the passing playback in the playback device as desired.

### <1.2.3. Playback Device 30>

The playback device 30 may be composed of a digital TV. The playback device 30 has a realtime playback function to receive the left-eye video when it is broadcast in real time over broadcast waves, and play back the 3D video in real time by combining the received left-eye video with the right-eye video that has been received via the network and stored in advance.

The playback device 30 has also a trick play function to perform a trick play by using only the stored right-eye video.

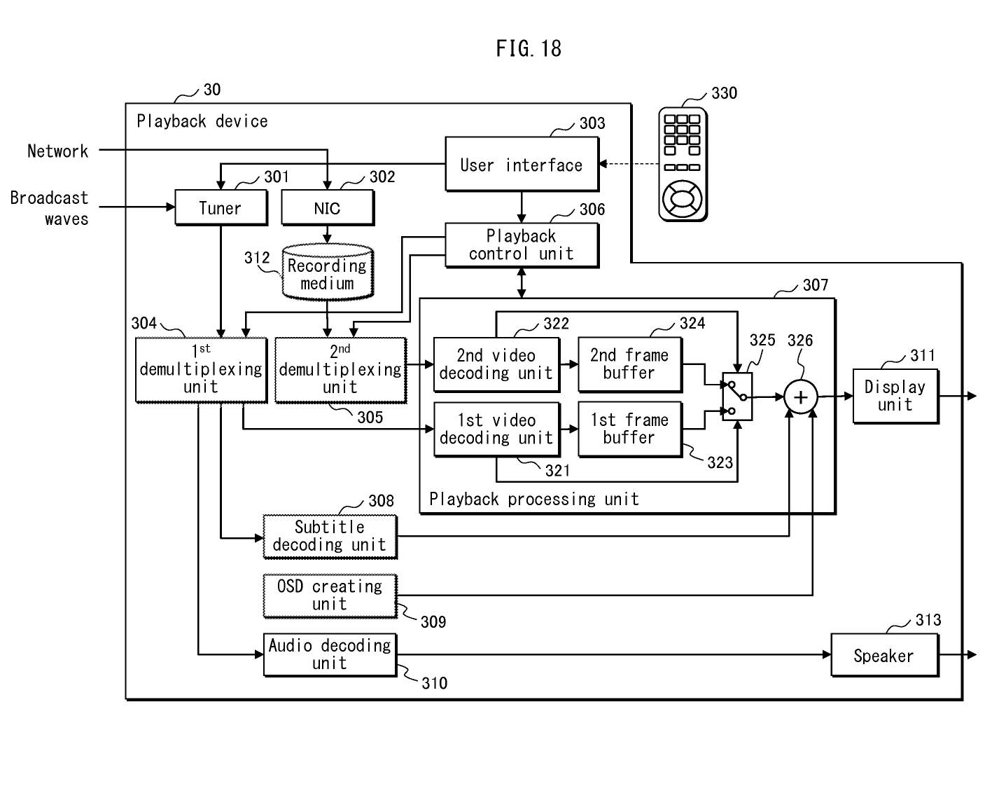

FIG. 18 is a block diagram illustrating the functional structure of the playback device 30.

As illustrated in FIG. 18, the playback device 30 includes: a tuner 301 as one example of a video receiving unit and an information obtaining unit; an NIC 302; a user interface 303; a first demultiplexing unit 304; a second demultiplexing unit 305; a playback control unit 306 as one example of a control unit; a playback processing unit 307 as one example of a playback unit; a subtitle decoding unit 308; an OSD (On-Screen Display) creating unit 309; an audio decoding unit 310; a display unit 311; a recording medium 312 as one example of a storage; and a speaker 313.

The playback device 30 further includes a processor and a memory, and the functions of the user interface 303, first demultiplexing unit 304, second demultiplexing unit 305, playback control unit 306, playback processing unit 307, subtitle decoding unit 308, OSD creating unit 309, audio decoding unit 310, and display unit 311 are realized as the processor executes a program stored in the memory.

### <Tuner 301>

The tuner 301 may be composed of a tuner for receiving digital broadcast waves. The tuner 301 receives digital broadcast waves broadcast by the transmission device 20, decodes the digital broadcast waves, extracts the left-eye TS from the decoded digital broadcast waves, and outputs the left-eye TS to the first demultiplexing unit 304.

### <NIC 302>

The NIC 302 may be composed of a communication LSI for performing data transmission/reception via the network. The NIC 302 is connected to the network, receives the stream output from the transmission device 20 (in the present embodiment, the right-eye TS), and stores the received stream in the recording medium 312.

### <User Interface 303>

The user interface 303 has a function to receive user instructions, such as a channel selection instruction and a power-off instruction, from a remote control 330.

As one example of the function, when it receives a channel change instruction sent from the user by using the remote control 330 or the like, the user interface 303 controls the tuner 301 to receive broadcast waves of a channel that is specified by the received instruction. This causes the tuner 301 to receive broadcast waves of the channel specified by the user.

### <First Demultiplexing Unit 304>

The first demultiplexing unit 304 may be composed of a demultiplexer LSI and has a function to obtain a TS conforming to MPEG-2 and separate the MPEG-2 TS into a video stream, an audio stream, information such as PSI/SI and the like. The first demultiplexing unit 304 separates the left-eye TS extracted by the tuner 301 into the left-eye video stream, SI/PSI, subtitle stream and audio stream, and outputs the separated left-eye video stream, subtitle stream and audio stream to the playback processing unit 307, subtitle decoding unit 308 and audio decoding unit 310, respectively. The first demultiplexing unit 304 also extracts the passing playback control descriptor from the EIT included in the SI, and notifies the playback control unit 306 of the extracted passing playback control descriptor.

### <Second Demultiplexing Unit 305>

The second demultiplexing unit 305 may be composed of a demultiplexer LSI and has a function to obtain a TS conforming to MPEG-2 and separate the MPEG-2 TS into a video stream, an audio stream, information such as PSI/SI and the like. The second demultiplexing unit 305 reads the right-eye TS, which has been stored in advance, from the recording medium 312, separates the right-eye video stream from the right-eye TS, and outputs the separated right-eye video stream to the playback processing unit 307.

### <Playback Control Unit 306>

The playback control unit 306 has an advance storage request function and a playback control function for controlling the execution of a realtime 3D playback and a trick play.

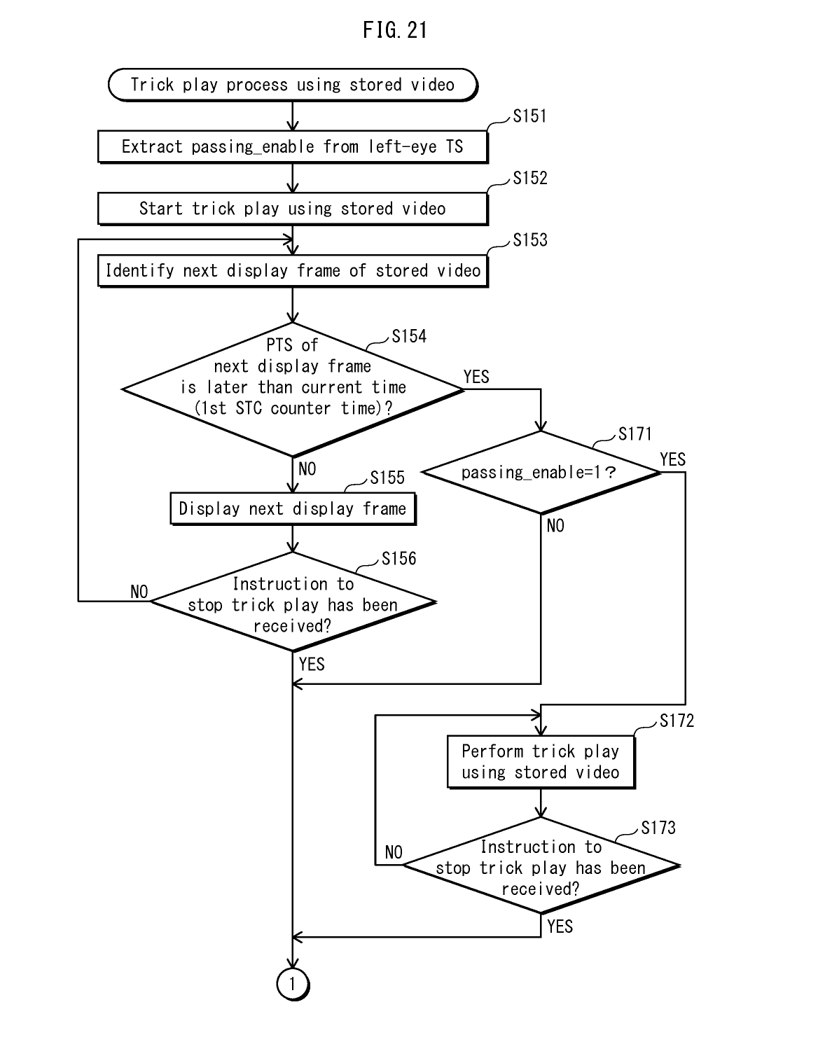

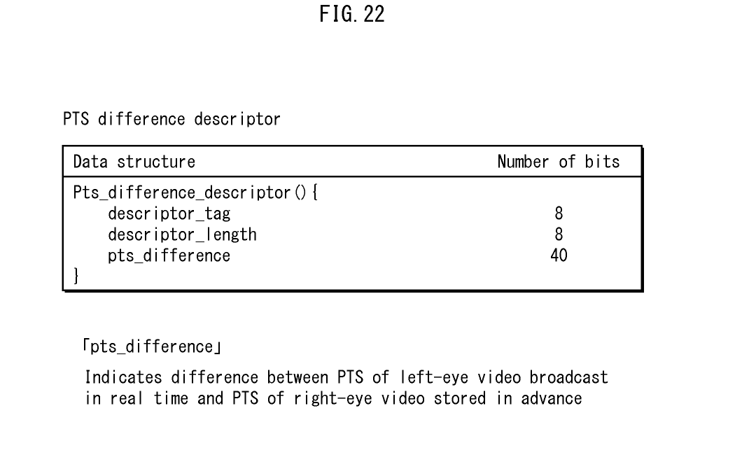

The video playback process based on the playback control function will be described later with reference to FIGS. 21 and 22. Here, a description is given of how to determine whether to permit the passing playback during a trick play.

The playback control unit 306 obtains a PTS from a second video decoding unit 322 for each right-eye video frame to be displayed next during the trick play process. Each time a PTS of a right-eye video frame is obtained, the second video decoding unit 322 reads the first STC counter time from a first video decoding unit 321. The playback control unit 306 then judges whether or not the time indicated by the obtained PTS is later than the first STC counter time.

The playback control unit 306 also receives, from the first demultiplexing unit 304, a passing playback control descriptor included in the EIT of the 3D video that is currently broadcast in real time and corresponds to the currently played-back right-eye video.

The playback control unit 306 then extracts the passing_enable from the passing playback control descriptor.

The playback control unit 306, when the time indicated by the obtained PTS is later than the first STC counter time and the passing_enable is set to 0, determines not to permit the passing playback and transmits, to the second video decoding unit 322, a request to change to the realtime 3D playback. On the other hand, when the passing_enable is set to 1, the playback control unit 306 determines to permit the passing playback and continues the trick play without sending any notification to the second video decoding unit 322. Furthermore, when the time indicated by the obtained PTS is equal to or earlier than the first STC counter time, the playback control unit 306 continues the trick play without sending any notification.

According to the above description, the playback device determines whether to permit the passing playback during the realtime broadcast of the left-eye video, by referencing the first STC counter time. However, during a period when the left-eye video is not broadcast in real time, the playback device can determine whether to permit the passing playback without referencing the first STC counter time. That is to say, referencing the EIT makes it possible to judge whether or not a left-eye video corresponding the playback-target right-eye video is in a realtime broadcast, and if the target right-eye video is to be played back before the realtime broadcast, the attempted playback can be determined as, without exception, the passing playback.

(2) Advance Storage Request Function

The advance storage request function is a function to select a right-eye video to be stored in advance, and request the transmission device 20 to transmit the selected right-eye video.

The playback control unit 306 realizes the advance storage request function (corresponding to S101 illustrated in FIG. 22) as follows.

The playback control unit 306 selects a right-eye video that constitutes a part of a 3D video that has been reserved for viewing before the realtime broadcast is performed by using broadcast waves.

The playback control unit 306 also selects a right-eye video that is to be stored in advance, based on the preference of the user. For example, the playback control unit 306 records a video viewing history of the user. When the viewing history indicates that action movies have been viewed frequently, the playback control unit 306 selects a right-eye video that constitutes a part of a 3D video of an action movie.

The playback control unit 306 transmits, to the transmission device 20, a transmission request that contains an ID of the selected right-eye video.

### <Playback Processing Unit 307>

The playback processing unit 307 may be composed of an AV signal processing LSI and executes the realtime playback function and the trick play function under the control of the playback control unit 306.

As illustrated in FIG. 18, the playback processing unit 307 includes a first video decoding unit 321, a second video decoding unit 322, a first frame buffer 323, a second frame buffer 324, a frame buffer switching unit 325, and an overlay unit 326.

(a) First Video Decoding Unit 321

The first video decoding unit 321 obtains a left-eye video stream from the first demultiplexing unit 304 and obtains left-eye video frames by decoding the left-eye video stream, and outputs the left-eye video frames to the first frame buffer 323.

The first video decoding unit 321 includes an STC (System Time Clock) counter for counting the STC, as is the case with a system that is typically used for decoding TSs conforming to MPEG-2. The first video decoding unit 321 adjusts the STC counter time based on the time indicated by the PCR (Program Clock Reference) included in the left-eye video stream. The first video decoding unit 321 then transfers each of the left-eye video frames from the first frame buffer 323 to the overlay unit 326 at each timing when a value of the PTS (Presentation Time Stamp) specified for a left-eye video frame matches the time indicated by the STC counter. Hereinafter, an STC counter provided in the first video decoding unit 321 is referred to as “first STC counter”, and the time indicated by the first STC counter is referred to as “first STC counter time”.

The left-eye video stream decoded by the first video decoding unit 321 is broadcast in real time by using broadcast waves, thus the PCR included in the left-eye video stream matches the current time. That is to say, the first STC counter time matches the current time.

The first video decoding unit 321 is configured to be able to read the first STC counter time from outside. In the present embodiment, the first STC counter time is read by the playback control unit 306.

(b) Second Video Decoding Unit 322

The second video decoding unit 322 has a function to obtain a right-eye video stream from the second demultiplexing unit 305 and obtain right-eye video frames by decoding the right-eye video stream, and output the right-eye video frames to the second frame buffer 324.

The second video decoding unit 322 includes an STC counter (hereinafter referred to as “second STC counter”) for counting the STC, as is the case with a system that is typically used for decoding TSs conforming to MPEG-2. The second video decoding unit 322 adjusts the time of the second STC counter based on the time of the PCR included in the right-eye video stream. The second video decoding unit 322 then transfers each of the right-eye video frames from the second frame buffer 324 to the overlay unit 326 at each timing when a value of the PTS specified for a right-eye video frame matches the time indicated by the second STC counter (hereinafter referred to as “second STC counter time”).

It should be noted here that the second video decoding unit 322 uses the second STC counter differently between a case where a realtime 3D playback is performed by using the left-eye and right-eye videos and a case where a trick play is performed by using the right-eye video, as described below.

(b1) Case where Realtime 3D Playback is Performed

The second video decoding unit 322 operates cooperatively with the first video decoding unit 321. The following describes the cooperative operation.

The right-eye video stream input to the second video decoding unit 322 is a stream that has been stored in advance, and is not a stream that is broadcast in real time. The right-eye video stream thus may be input to the second video decoding unit 322 at arbitrary timing. As a result, if a PCR is extracted from a right-eye video stream that is input to the second video decoding unit 322 at arbitrary timing, and the second STC counter is adjusted by using the extracted PCR, the second STC counter time will not match the first STC counter time that indicates the current time.

Accordingly, to cause the second STC counter time to match the first STC counter time during a playback of a 3D video, the second video decoding unit 322 references a PCR (hereinafter referred to as “first PCR”) that has been extracted by the first video decoding unit 321 for a realtime playback, extracts, from the right-eye video stream, a PCR (hereinafter referred to as “second PCR”) that matches the first PCR, and starts decoding from a portion having the second PCR.

This makes it possible for the second STC counter time and the first STC counter time to be synchronized. A left-eye video frame and a right-eye video frame in a pair are then transferred to the overlay unit 326 in accordance with the respective PTSs thereof, thereby realizing a 3D display on the display unit 311.

(b2) Case where Trick Play is Performed

In this case, as is the case in a general MPEG-2 system, PCRs extracted from the right-eye video stream and the second STC counter time are disregarded, and the right-eye video frames are decoded and displayed in a predetermined order.

In this case, the second video decoding unit 322 notifies the playback control unit 306 of PTSs in sequence that are each specified for the right-eye video frame that is to be displayed next.

When, as a response to the notification, a request to change to the realtime 3D playback is received from the playback control unit 306, the second video decoding unit 322 stops the trick play, and changes from the trick play to the above-described realtime 3D playback.

Note that, when a trick play is performed, the left-eye video is not displayed, but the first STC counter needs to be referenced. Accordingly, it is necessary to obtain the left-eye video stream from the realtime broadcast waves, extract PCRs from the left-eye video stream, and causes the first STC counter to operate by using the extracted PCRs.

(c) First Frame Buffer 323

The first frame buffer 323 may be composed of a frame buffer. The first frame buffer 323 stores left-eye video frames output from the first video decoding unit 321.

(d) Second Frame Buffer 324

The second frame buffer 324 may be composed of a frame buffer. The second frame buffer 324 stores right-eye video frames output from the second video decoding unit 322.

(e) Frame Buffer Switching Unit 325

The frame buffer switching unit 325 may be composed of a switch. The frame buffer switching unit 325 has a connection switching function to connect either the first frame buffer 323 or the second frame buffer 324 to the overlay unit 326 to switch between videos output to the display unit 311.

The frame buffer switching unit 325 realizes the connection switching function as follows.

The frame buffer switching unit 325 receives either the 3D playback instruction or the 2D playback instruction from the playback control unit 306. Upon receiving the 3D playback instruction, the frame buffer switching unit 325 alternately connects the first frame buffer 323 and the second frame buffer 324 to the overlay unit 326. This switching by the frame buffer switching unit 325 is performed at 120 Hz, as one example of the switching cycle. In that case, the overlay unit 326 reads a left-eye video frame and a right-eye video frame alternately, for example, at 120 Hz of switching cycle, and the read video frames are displayed on the display unit 311. This makes it possible for the user to view the 3D video when he/she views the display while wearing the 3D glasses.

Upon receiving the 2D playback instruction, the frame buffer switching unit 325 connects the second frame buffer 324 to the overlay unit 326. In that case, the overlay unit 326 reads a right-eye video frame, for example, at 120 Hz of cycle, and the read video frames are displayed on the display unit 311. This makes it possible for the user to view the 2D video.

(f) Overlay Unit 326

The overlay unit 326 reads a video frame from a frame buffer, to which it is connected, at a predetermined reading cycle (in the present embodiment, at 120 Hz, as one example) via the frame buffer switching unit 325, overlays, as necessary, the subtitle data decoded by the subtitle decoding unit 308 and the information created by the OSD creating unit 309 on the read video frame, and outputs the overlay result to the display unit 311.

### <Subtitle Decoding Unit 308>

The subtitle decoding unit 308 may be composed of a subtitle signal processing LSI. The subtitle decoding unit 308 has a function to generate a subtitle by decoding a subtitle data stream received from the first demultiplexing unit 304 and output the generated subtitle to the playback processing unit 307. The present invention is weakly related to the structure and processing of the subtitle, and OSD and audio, which are described below, and thus detailed description thereof is omitted.

### <OSD Creating Unit 309>

The OSD creating unit 309 may be composed of an OSD processing LSI that obtains PSI/SI and generates an OSD by analyzing and processing the obtained PSI/SI. The OSD creating unit 309 has a function to generate an OSD and output the generated OSD to the playback processing unit 307, wherein the OSD is used for displaying channel number, broadcasting station name and so on, together with the currently received broadcast program.

### <Audio Decoding Unit 310>

The audio decoding unit 310 has a function to generate audio data by decoding an audio stream received from the first demultiplexing unit 304, and output the generated audio data as audio via the speaker 313.

<Display unit 311>

The display unit 311 displays video frames received from the overlay unit 326, as video on a display (not illustrated).

### <Recording Medium 312>

The recording medium 312 may be composed of a nonvolatile storage device. The recording medium 312 the right-eye TS received from the NIC 302.

### <Speaker 313>

The speaker 313 may be composed of a speaker, and outputs the audio data decoded by the audio decoding unit 310 as audio.

### <1.3. Operation>

The following describes the video transmission process performed by the transmission device 20, and the video playback process performed by the playback device 30.

### <1.3.1. Video Transmission Process Performed by Transmission Device 20>

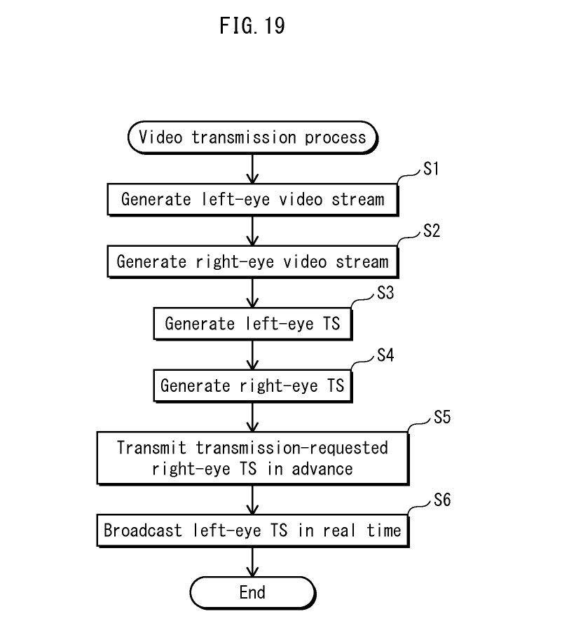

The following describes the video transmission process performed by the transmission device 20, with reference to the flowchart illustrated in FIG. 19.

First, the first video encoding unit 206 of the transmission device 20 generates a left-eye video stream by encoding a left-eye video stored in the video storage 201, and outputs the generated left-eye video stream to the first multiplexing processing unit 208 (S1).

Subsequently, the second video encoding unit 207 generates a right-eye video stream by encoding a right-eye video stored in the video storage 201 (S2).

The first multiplexing processing unit 208 generates a left-eye TS by multiplexing the various types of information stored in the stream management information storage 202, subtitle stream storage 203, and audio stream storage 204, and stores the generated left-eye TS into the first TS storage 210 (S3).

Also, the second multiplexing processing unit 209 generates a right-eye TS by multiplexing the right-eye video stream generated in step S1 and stores the generated right-eye TS into the second TS storage 211 (S4).

The NIC 213, upon receiving a right-eye video transmission request, transmits the right-eye TS stored in the second TS storage 211 to the request source of the right-eye video transmission request (playback device 30) in advance (S5).

The broadcasting unit 212 starts broadcasting the left-eye TS stored in the first TS storage 210 when the scheduled broadcast time comes (S6).

<1.3.2. Video playback process performed by playback device 30>

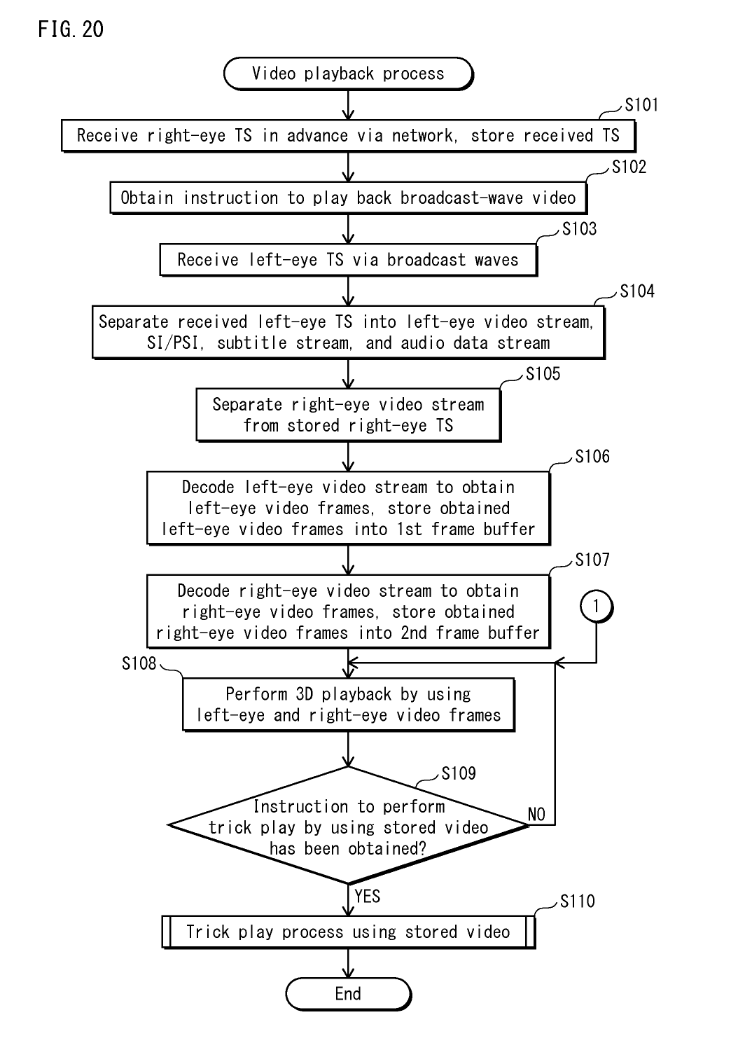

The following describes the video playback process, which is performed based on the above-described playback control function, with reference to FIG. 20.

First, the NIC 302 of the playback device 30 receives the right-eye TS in advance, and stores the right-eye TS in the recording medium 312 (step S101).

Next, the user interface 303 of the playback device 30 receives a channel selection instruction from the user (step S102). The tuner 301 receives broadcast waves of a channel specified by the channel selection instruction, and obtains a left-eye TS by demodulating the received broadcast waves (step S103).

The first demultiplexing unit 304 demultiplexes the left-eye TS into a left-eye video stream, SI/PSI, subtitle data stream, audio data stream and the like. The first demultiplexing unit 304 then outputs the left-eye video stream, subtitle stream, and audio stream to the playback processing unit 307, subtitle decoding unit 308, and audio decoding unit 310, respectively.

The second demultiplexing unit 305 then reads the right-eye TS, which has been stored in advance, from the recording medium 312, and obtains a right-eye video stream by demultiplexing the right-eye TS (step S105). The second demultiplexing unit 305 outputs the right-eye video stream to the playback processing unit 307.

The first video decoding unit 321 of the playback processing unit 307 obtains left-eye video frames by decoding the left-eye video stream, and stores the obtained left-eye video frames into the first frame buffer 323 (step S106).

The second video decoding unit 322 obtains right-eye video frames by decoding the right-eye video stream, and stores the obtained right-eye video frames into the second frame buffer 324 (step S107).

The overlay unit 326 reads a left-eye video frame and a right-eye video frame alternately from the first frame buffer 323 and the second frame buffer 324, and displays the read video frames on the display of the display unit 311.

The playback control unit 306 waits for the user interface 303 to obtain an instruction to perform a trick play by using the stored video (NO in step S109).

When an instruction to perform a trick play by using the stored video is obtained (YES in step S109), the trick play process is performed by using the stored video (step S110).

FIG. 21 is a flowchart of the trick play process using the stored video, which is performed in step S110 of FIG. 20.

First, the playback control unit 306 extracts the passing playback control descriptor from the EIT contained in the SI obtained by the first demultiplexing unit 304, and reads passing_enable from the passing playback control descriptor (step S151).

The playback control unit 306 then instructs the playback processing unit 307 to start the trick play by using the stored video (step S152).

The second video decoding unit 322 of the playback processing unit 307 identifies the right-eye video frame to be displayed next (hereinafter referred to as “next display frame”) in accordance with a predetermined presentation order of the right-eye video frames of the stored right-eye video (step S153).

The second video decoding unit 322 notifies the playback control unit 306 of the PTS of the next display frame.

The playback control unit 306 reads the first STC counter time from the first video decoding unit 321, and judges whether or not the time indicated by the notified PTS is later than the current time, namely, the first STC counter time (step S154).

When it judges that the time indicated by the notified PTS is not later than the current time (NO in step S154), the playback control unit 306 continues the trick play without sending any notification to the second video decoding unit 322.

In that case, the second video decoding unit 322 decodes the next display frame, and stores the decoded next display frame in the second frame buffer 324. The overlay unit 326 reads the next display frame from the second frame buffer 324, and displays the next display frame on the display of the display unit 311 (step S155).

After this, the trick play is continued until a trick play stop instruction is obtained (when it is judged NO in step S156, the control returns to step S153); or the realtime 3D playback is performed when the trick play stop instruction is obtained (when it is judged YES in step S156, the control proceeds to step S108).

When it is judged that the time indicated by the notified PTS is later than the first STC counter time (YES in step S154) and it is judged that the passing_enable is set to 0 (NO in step S171), the trick play is stopped and it returns to the realtime 3D playback (step S108).

When it is judged that the passing_enable is set to 1 (YES in step S171), the trick play is continued (step S172) until a trick play stop instruction is obtained (when it is judged NO in step S173, the control returns to step S153). The realtime 3D playback is performed when the trick play stop instruction is obtained (when it is judged YES in step S173, the control proceeds to step S108).

### <2. Modifications>

Although the video transmission/reception system of the present invention has been described through an embodiment, the present invention is not limited to the video transmission/reception system described above as one example, but may be modified, for example, as follows.

(1) In the above-described embodiment, no expiration date is set for the passing playback control descriptor. However, not limited to this structure, an expiration date may be set for the passing playback control descriptor. This makes it possible to control in more detail whether to permit the passing playback.

The “start_time”, which is illustrated in FIG. 17 as one example of the use start date and time contained in the passing playback control descriptor, indicates, by Japan standard time and Modified Julian Date, the start day and time of the period during which the passing playback is permitted. All of 40 bits are set to 1 when the start day and time of the period during which the passing playback is permitted are not set.

In the present modification, the playback control unit 306 of the playback device 30 references the start_time as well when it references the passing_enable contained in the passing playback control descriptor. The playback control unit 306 then judges whether or not the start_time is later than the current time (the first STC counter time), and when it judges that the start_time is not later than the current time, determines not to permit the passing playback, regardless of the value of the passing_enable. On the other hand, when the start_time is later than the current time (the first STC counter time), the playback control unit 306 determines whether to permit the passing playback, in accordance with the value of the passing_enable.

Note that the start_time is assumed to be set in the following case, for example.

There may be adopted a 3D video transmission form in which the transmission device 20 repeatedly broadcasts the left-eye video at different dates and times, and transmits the right-eye video once in advance. In that case, once the left-eye video is broadcast in real time, the right-eye video can be regarded as having been viewed already as well and published. It may further be considered that, after the right-eye video is published, there is no problem in permitting the passing playback.

In that case, the broadcasting organization may specify, in the start_time, the start date and time of a period during which there is no problem in permitting the passing playback.

(2) In the above-described embodiment, the timing for deleting the right-eye video is not mentioned. However, the right-eye video may be deleted at the following timing, for example.

(a) Deleted once the right-eye video is viewed by viewers.

(b) Deleted in accordance with information indicating the deletion date and time transmitted by the transmission device 20.

In the case of the above (b), the transmission device 20 may transmit, via broadcast waves or network communication, date and time information indicating the deletion date and time of the right-eye video, such as “delete_time” contained in the passing playback control descriptor illustrated in FIG. 17.

The delete_time indicates the date and time at which the video (in the embodiment and modification, the right-eye video) having been stored in advance is to be deleted.

In those cases, the playback device 30 may include a deleting unit (not illustrated).

The deleting unit obtains the date and time information indicating the deletion date and time of the right-eye video, as described in (b) above, checks the current date and time, and judges whether or not the current time has reached the date and time indicated by the date and time information.

When the current time reaches the date and time indicated by the date and time information, the deleting unit deletes the right-eye video.

(3) In the case where the 3D video transmission form described in the modification (1) above is adopted, wherein the transmission device 20 repeatedly broadcasts the left-eye video at different dates and times and transmits the right-eye video once in advance, a left-eye video frame and a right-eye video frame in a pair may have different PTSs. For example, a left-eye video frame, which is the first in the presentation order of the video frames of the left-eye video, is assigned a PTS (referred to as “first PTS” for convenience's sake) for the first broadcast and a PTS (referred to as “second PTS” for convenience's sake) for the second broadcast, and the first PTS and the second PTS indicate different times.

For a right-eye video frame, which is the first in the presentation order of the video frames of the right-eye video, to be displayed in the first realtime broadcast, it must be displayed at the time indicated by the first PTS, and to be displayed in the second realtime broadcast, it must be displayed at the time indicated by the second PTS.

In view of this, a PTS having a value starting with 0 is assigned to each of the right-eye video frames constituting the right-eye video so that the right-eye video can be displayed appropriately in both the first and second broadcasts.

In addition, information indicating a difference between the PTS of the right-eye video frame and the PTS of the left-eye video frame for the first broadcast is included in information such as the EIT, and the first broadcast is performed in real time. Also, information indicating a difference between the PTS of the right-eye video frame and the PTS of the left-eye video frame for the second broadcast is included in information such as the EIT, and the second broadcast is performed in real time.

In this structure, the playback device 30, when playing back a right-eye video frame, displays the right-eye video frame at a time which is obtained by adding the difference to the PTS of the right-eye video frame.

FIG. 22 is a diagram illustrating the data structure of a PTS difference descriptor, which is one example of the above-described information describing the difference between the PTSs.

The “pts_difference” is a 40-bit field indicating a difference between the PTS of the left-eye video that is broadcast in real time and the PTS of the right-eye video that is stored in advance.

Note that, as an STC (System Time Clock) used as the reference time in the display of the right-eye video, an STC that is used in decoding of the left-eye video may be used, or an STC measuring the same time as that may be prepared separately for use.

Note that in that case, the PTS of a video frame of the left-eye video that is displayed first in the first, the second, . . . realtime broadcasts may correspond to the first initial time, and the PTS (as one example, “0”) assigned to a video frame of the right-eye video that is displayed first may correspond to the second initial time.

(4) In the above-described embodiment and modification, the passing playback control descriptor and the PTS difference descriptor are additionally included in the EIT. However, not limited to this structure, any mechanism may be adopted as far as the same meaning can be transmitted. For example, “reserved_future_use”, which is composed of reserved bits, may be modified to have the same meaning as the passing playback control descriptor and the PTS difference descriptor.

Furthermore, the passing playback control descriptor and the PTS difference descriptor may not necessarily be broadcast via broadcast waves, but may be transmitted from the transmission device 20 to the playback device 30 via a network.

(5) In the above-described embodiment, the right-eye video is transmitted from the transmission device 20 to the playback device 30 via a network. However, not limited to this structure, any other structure may be adopted as far as the right-eye video can be transmitted. For example, before broadcasting the left-eye video for the 3D video in real time, the transmission device 20 may transmit the right-eye video in advance over broadcast waves. More specifically, the transmission device 20 may transmit the right-eye video in a period of time when the regular broadcast is not performed, such as in the middle of the night, or may transmit the right-eye video by using a free broadcast channel.

This enables existing 2D broadcast equipment to be used to transmit the right-eye video as well, eliminating the need to use the network.

In the above-described embodiment, the left-eye video and the right-eye video are converted into the MPEG-2 TS format, and then transmitted from the transmission device 20 to the playback device 30. However, not limited to this structure, any other structure may be adopted as far as these videos can be transmitted.

For example, these videos may be transmitted after being converted into another container format such as mp4 (MPEG-4).

(6) As described briefly in the modification (3) above, in the case where the 3D video transmission form is adopted, wherein the transmission device 20 repeatedly broadcasts the left-eye video at different dates and times and transmits the right-eye video once in advance, a left-eye video frame and a right-eye video frame in a pair may have different PTSs.

In view of this, as information for causing the left-eye video frame and the right-eye video frame to be displayed in synchronization, a time stamp may be assigned to each of the left-eye video frame and the right-eye video frame, wherein the time stamp is information that indicates a scheduled presentation time of the frame as the PTS does, and is created based on a time axis that is common to the left-eye video frame and the right-eye video frame.

By referencing the time stamp, the playback device can display a left-eye video frame and a corresponding right-eye video frame in synchronization with ease without being affected by the broadcast time of the left-eye video.

(7) In the above-described embodiment, the passing playback control descriptor is used to determine whether to permit the passing playback. However, not limited to this, any other information may be used as far as it makes it possible to determine whether to permit the passing playback. For example, information indicating whether or not playback of a 3D video is permitted only as a 3D video may be used to determine whether to permit the passing playback.

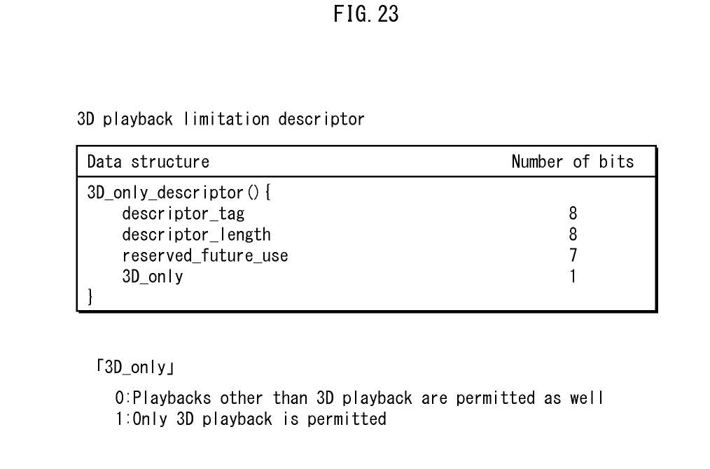

FIG. 23 is a diagram illustrating the data structure of a 3D playback limitation descriptor in the present modification.

The 3D playback limitation descriptor includes “descriptor_tag”, “descriptor_length”, “reserved_future_use”, and “3D_only”.

The descriptor_tag, descriptor_length, and reserved_future_use are the same as those included in other descriptors.

The 3D_only is information indicating whether or not playback of a 3D video is permitted only as a 3D video, and 3D_only set to 1 indicates that only 3D playback is permitted, and the 3D_only set to 0 indicates that playbacks other than 3D playback are permitted as well.

The playback control unit 306 of the playback device 30 references the 3D_only when a trick play is performed.

When the 3D_only is set to 1, the playback control unit 306 performs a control to execute only 3D playback. That is to say, in this case, the playback control unit 306 executes neither a playback of only the right-eye video, nor a trick play.

On the other hand, when the 3D_only is set to 0, the playback control unit 306 performs a control to execute a playback even if the playback is other than the 3D playback. That is to say, in this case, the playback control unit 306 may execute a playback of only the right-eye video, or a trick play.

Note that both the passing playback control descriptor and the 3D playback limitation descriptor may be used to perform the control in more detail. In that case, the playback control unit 306 may be configured to determine to permit the passing playback when the 3D_only is set to 0 and the passing_enable is set to 1.

When viewing a 3D video in which switching among 3D depths occurs frequently, some viewers may feel “3D sickness”.

For example, in the case of a broadcast program that was recorded in a studio of a broadcasting station by using a camera fixed to almost the same position, the 3D depth in the 3D video rarely changes. If such a 3D video is played back at a high speed, viewers rarely feel “3D sickness” or the like. On the other hand, in the case of a 3D video such as an action movie in which the camera angle changes frequently and thus the 3D depth changes frequently, playing back the 3D video at a high speed would cause many viewers to feel “3D sickness” or the like.

For this reason, for example, the above-described 3D playback limitation descriptor may be extended or another descriptor may be included as trick play inhibition/permission information that indicates “3D trick play is inhibited”, “3D trick play may be inhibited (the playback device side determines whether to permit the trick play)”, or “3D trick play is permitted”.

In this case, the playback device 30 receives the trick play inhibition/permission information, and determines whether to permit the trick play in accordance with the received trick play inhibition/permission information. With this structure, the broadcasting organization can instruct the playback device to avoid trick plays during playback of a 3D video that may cause a “3D sickness”.

(8) A control program, which is composed of program codes written in a machine language or a high-level language that causes processors of the transmission device 20 and the playback device 30 or various circuits connected to the processors to execute such processes as the video transmission process and the video playback process described in the embodiment and modifications above, may be recorded on a recording medium and distributed in that form via any of various types of communication paths. Such recording mediums include an IC card, a hard disk, an optical disc, a flexible disc, a ROM, and a flash memory. The control program distributed as such may be stored in a memory or the like that can be read by the processor, and the functions described in the embodiment and modifications are realized when the processor executes the control program. Note that the processor may execute the control program directly, or execute it after compiling, or execute it via an interpreter.

(9) The various functional structural elements indicated in the embodiment above (the video storage 201, stream management information storage 202, subtitle stream storage 203, audio stream storage 204, encoding processing unit 205, first multiplexing processing unit 208, second multiplexing processing unit 209, first TS storage 210, second TS storage 211, broadcasting unit 212, NIC 213, tuner 301, NIC 302, user interface 303, first demultiplexing unit 304, second demultiplexing unit 305, playback control unit 306, playback processing unit 307, subtitle decoding unit 308, OSD creating unit 309, audio decoding unit 310, display unit 311, recording medium 312, speaker 313 and the like) may be realized as circuits for executing respective functions, or may be realized as one or more processors executing one or more programs.

(10) Note that typically, the above-described various functional structural elements are realized as LSIs that are integrated circuits. Each of these elements may be separately implemented on one chip, or part or all of the elements may be implemented on one chip. Although the term “LSI” is used here, it may be called IC, system LSI, super LSI, ultra LSI or the like, depending on the level of integration. Also, an integrated circuit may not necessarily be manufactured as an LSI, but may be realized by a dedicated circuit or a general-purpose processor. It is also possible to use the FPGA (Field Programmable Gate Array), with which a programming is available after the LSI is manufactured, or the reconfigurable processor that can re-configure the connection or setting of the circuit cells within the LSI. Furthermore, a technology for an integrated circuit that replaces the LSI may appear in the near future as the semiconductor technology improves or branches into other technologies. In that case, the new technology may be incorporated into the integration of the functional blocks. Such possible technologies include biotechnology.

(11) The present invention may be the above-described method.

(12) The present invention may be a partial combination of the above-described embodiment and modifications.

### <3. Supplementary Explanation 1>

The following describes the structure of a video playback device that is one embodiment of the present invention, and modifications and effects thereof.

(1) According to one embodiment of the present invention, there is provided a video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback device comprising: a storage storing the second view-point video; a video receiving unit configured to receive the first view-point video over the broadcast waves; an information obtaining unit configured to obtain inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback; a playback unit configured to play back the second view-point video; and a control unit configured to inhibit the second view-point video from being played back when the scheduled presentation time of a next video frame, which is a video frame to be displayed next, is later than current time and the inhibition/permission information indicates that displaying the next video frame is inhibited.

With the above-described structure, the video playback device can control appropriately, by using the inhibition/permission information, whether to permit a playback of a video frame, which is stored in advance, before current time reaches a scheduled presentation time that is a time at which the video frame is scheduled to be broadcast for the realtime playback.

(2) In the above-stated video playback device, the inhibition/permission information may be transmitted over the broadcast waves, and the information obtaining unit may receive the broadcast waves and obtain the inhibition/permission information from the broadcast waves.

With the above-described structure, the video playback device can obtain the inhibition/permission information when the device that transmits the inhibition/permission information transmits it over the broadcast waves.

(3) In the above-stated video playback device, the inhibition/permission information may be stored in the storage, and the information obtaining unit may obtain the inhibition/permission information by reading the inhibition/permission information from the storage.

With the above-described structure, the video playback device can obtain the inhibition/permission information when the device that transmits the inhibition/permission information transmits it in advance.

(4) In the above-stated video playback device, the inhibition/permission information may contain information indicating date and time at which use of the inhibition/permission information is to be started, the information obtaining unit may obtain the information indicating the date and time, and the control unit may inhibit the second view-point video from being played back when the date and time indicated by the obtained information is later than the current time, even when the inhibition/permission information indicates that a display is permitted.

With the above-described structure, it is possible to set a term of validity for the inhibition/permission information and control, in more detail, whether to permit a playback of a video frame before current time reaches a scheduled presentation time that is a time at which the video frame is scheduled to be broadcast for the realtime playback.

(5) In the above-stated video playback device, the information obtaining unit may further obtain date-and-time information that indicates date and time at which the second view-point video stored in the storage is to be deleted, and the video playback device may further comprise a deleting unit configured to delete the second view-point video stored in the storage when the current time reaches the date and time indicated by the date-and-time information.

With the above-described structure, it is possible to prevent the second view-point video from continuing to be stored in the storage and pressing the recording capacity of the storage.

(6) In the above-stated video playback device, each of a sequence of video frames constituting the first view-point video may be assigned a scheduled display time that is set based on a first initial time, each of a sequence of video frames constituting the second view-point video may be assigned a scheduled display time that is set based on a second initial time that is different from the first initial time, the information obtaining unit may further obtain a difference time between the first initial time and the second initial time, and the control unit may use, as the scheduled presentation time of the next video frame at which the next video frame is scheduled to be broadcast for the realtime playback, a time that is obtained by adding the difference time to a scheduled display time assigned to the next video frame.

With the above-described structure, even in the case where the second view-point video is combined with any of a plurality of first view-point videos, it is possible to display video frames of the first and second view-point videos, which correspond to each other, in synchronization.

(7) According to another embodiment of the present invention, there is provided a video playback method for use in a video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback method comprising: a storing step of storing the second view-point video; a video receiving step of receiving the first view-point video over the broadcast waves; an information obtaining step of obtaining inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback; a playback step of playing back the second view-point video; and a control step of inhibiting the second view-point video from being played back when the scheduled presentation time of a next video frame, which is a video frame to be displayed next, is later than current time and the inhibition/permission information indicates that displaying the next video frame is inhibited.

According to yet another embodiment of the present invention, there is provided a video playback program for causing a computer to function as a video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback program causing the computer to function as: a storage storing the second view-point video; a video receiving unit configured to receive the first view-point video over the broadcast waves; an information obtaining unit configured to obtain inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback; a playback unit configured to play back the second view-point video; and a control unit configured to inhibit the second view-point video from being played back when the scheduled presentation time of a next video frame, which is a video frame to be displayed next, is later than current time and the inhibition/permission information indicates that displaying the next video frame is inhibited.

With the above-described structure, the video playback device can control appropriately, by using the inhibition/permission information, whether to permit a playback of a video frame, which is stored in advance, before current time reaches a scheduled presentation time that is a time at which the video frame is scheduled to be broadcast for the realtime playback.

(8) According to a further embodiment of the present invention, there is provided a video transmission device for transmitting a 3D video that is to be played back in real time by playing back a first view-point video and a second view-point video in combination, the video transmission device comprising: a realtime transmission unit configured to broadcast the first view-point video in real time; an advance transmission unit configured to transmit the second view-point video in advance before the first view-point video is broadcast in real time; and an information transmission unit configured to transmit inhibition/permission information that indicates whether displaying a video frame before current time reaches a scheduled presentation time is inhibited or permitted.

With the above-described structure, it is possible for the video transmission device to control appropriately, by using the inhibition/permission information in the video playback device for performing a playback of 3D video, whether to permit a playback of a video frame, which is stored in advance, before current time reaches a scheduled presentation time that is a time at which the video frame is scheduled to be broadcast for the realtime playback.

(9) In the above-stated video transmission device, the information transmission unit may transmit the inhibition/permission information over broadcast waves.

With the above-described structure, it is possible to transmit the inhibition/permission information to a video playback device that is structured to obtain the inhibition/permission information over broadcast waves.

(10) In the above-stated video transmission device, the inhibition/permission information transmitted by the information transmission unit may contain information indicating date and time at which use of the inhibition/permission information is to be started.

With the above-described structure, it is possible to set a term of validity for the inhibition/permission information and cause the video playback device to control, in more detail, whether to permit a playback of a video frame before current time reaches a scheduled presentation time that is a time at which the video frame is scheduled to be broadcast for the realtime playback.

(11) In the above-stated video transmission device, the information transmission unit may further transmit date-and-time information that indicates date and time at which the second view-point video is to be deleted.

With the above-described structure, it is possible to control the video playback device to prevent the second view-point video from continuing to be stored in the storage and pressing the recording capacity of the storage.

(12) In the above-stated video transmission device, each of a sequence of video frames constituting the first view-point video may be assigned a scheduled display time that is set based on a first initial time, each of a sequence of video frames constituting the second view-point video may be assigned a scheduled display time that is set based on a second initial time that is different from the first initial time, and the information transmission unit may further transmit a difference time between the first initial time and the second initial time.

With the above-described structure, even in the case where the second view-point video is combined with any of a plurality of first view-point videos, it is possible to cause the video playback device to display video frames of the first and second view-point videos, which correspond to each other, in synchronization.

(13) According to a yet further embodiment of the present invention, there is provided a video transmission method for use in a video transmission device for transmitting a 3D video that is to be played back in real time by playing back a first view-point video and a second view-point video in combination, the video transmission method comprising: a realtime transmission step of broadcasting the first view-point video in real time; an advance transmission step of transmitting the second view-point video in advance before the first view-point video is broadcast in real time; and an information transmission step of transmitting inhibition/permission information that indicates whether displaying a video frame before current time reaches a scheduled presentation time is inhibited or permitted.

According to a yet further embodiment of the present invention, there is provided a video transmission program for causing a computer to function as a device for transmitting a 3D video that is to be played back in real time by playing back a first view-point video and a second view-point video in combination, the video transmission program causing the computer to function as: a realtime transmission unit configured to broadcast the first view-point video in real time; an advance transmission unit configured to transmit the second view-point video in advance before the realtime transmission unit broadcasts the first view-point video in real time; and an information transmission unit configured to transmit inhibition/permission information that indicates whether displaying a video frame before current time reaches a scheduled presentation time is inhibited or permitted.

With the above-described structure, it is possible for the video transmission device to control appropriately, by using the inhibition/permission information in the video playback device for performing a playback of 3D video, whether to permit a playback of a video frame, which is stored in advance, before current time reaches a scheduled presentation time that is a time at which the video frame is scheduled to be broadcast for the realtime playback.

### <4. Supplementary Explanation 2>

The following is a supplementary explanation of the above-described embodiment.

<Principle of Stereoscopic Viewing>

First, the principle of stereoscopic viewing is briefly described. Methods of implementing stereoscopic viewing include a light reproduction method which relies on holography and a method which uses parallax images.

First, the light reproduction method relying on holography is characterized by reproducing an object stereoscopically in exactly the same way as a person would perceive a normal object. A technical theory for utilizing holography to generate video has been established. However, it is extremely difficult to construct, with current technology, either a computer that is capable of the enormous amount of calculation required for real-time generation of video for holography, or a display device having a resolution several thousand lines per millimeter. Nearly no example exists of a commercial product of such devices in practical use.

Next, a method employing parallax images is described. Generally, due to the difference in location between the right eye and the left eye, the image seen by the right eye differs slightly from the image seen by the left eye. Based on this difference, people can perceive visible images as stereoscopic. In the stereoscopic display using parallax images, human perception of parallax is used to allow for people to view two-dimensional images stereoscopically.

The advantage of this method is that stereoscopic viewing can be achieved by preparing video images merely from two viewpoints, namely right-eye video and left-eye video. The technical point of this method is how to show the right-eye video and left-eye video to the corresponding eyes, respectively. A variety of forms of technology, which differ in this point, have been put to practical use, including the sequential segregation method.

The sequential segregation method is a method for alternately displaying the left-eye video and the right-eye video along the time axis. Due to the afterimage phenomenon of the eyes, the left and right scenes are overlaid within the brain, causing a viewer to perceive the scenes as stereoscopic images.

In addition to a method for preparing separate video images for the right eye and for the left eye, another method of stereoscopic viewing using parallax images is to prepare a separate depth map that indicates a depth value for each pixel in a 2D video image. Based on the depth map for the 2D video image, the player or display generates parallax video images each consisting of a left-eye video image and a right-eye video image.

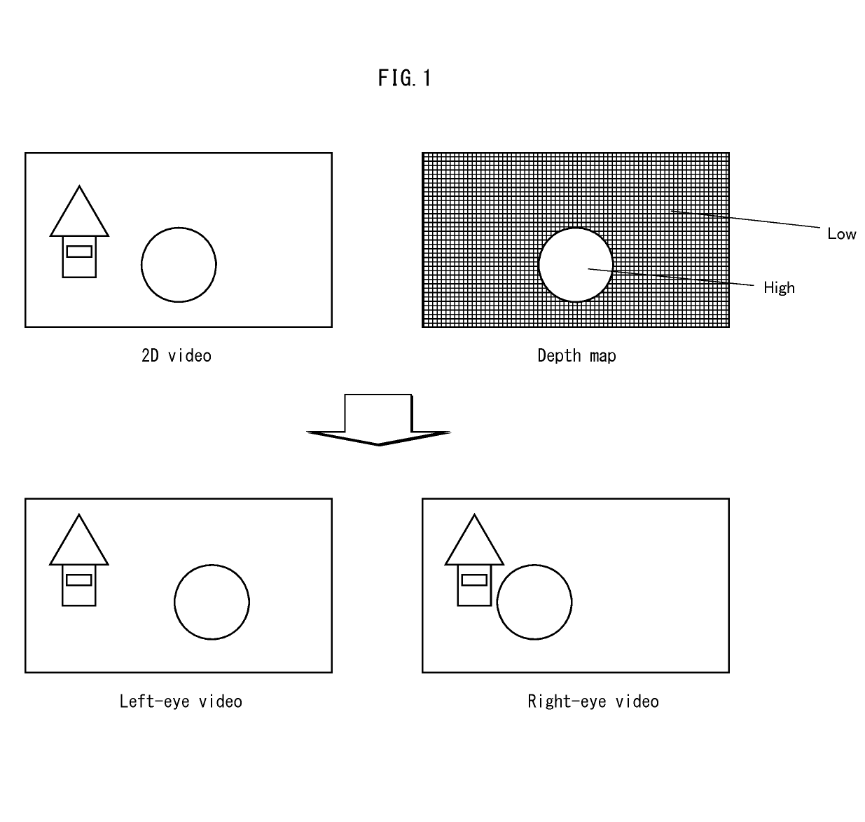

FIG. 1 schematically illustrates an example of generating parallax video consisting of left-eye video and right-eye video from 2D video and a depth map. The depth map contains a depth value for each pixel in the 2D video image. In the example in FIG. 1, the depth map includes information indicating that the circular object in the 2D video image has a high depth value, whereas other regions have a low depth value. This information may be stored as a bit sequence for each pixel, or as images (such as an image that is “black” to indicate a low depth value and an image that is “white” to indicate a high depth value). A parallax image can be created by adjusting the parallax amount of 2D video based on the depth values contained in the depth map. In the example illustrated in FIG. 1, the circular object in the 2D video has a high depth value while the other regions have a low depth value, thus the parallax amount of the pixels constituting the circular object is increased and the parallax amount of the pixels constituting the other regions is decreased when the left-eye and right-eye video images are created as the parallax images. Displaying the left-eye and right-eye video images by the sequential segregation method or the like allows for a stereoscopic viewing to be realized.

This concludes the description of the principle of stereoscopic viewing.

<Use Form of Playback Device 30>

The following describes the use form of the playback device 30.

The playback device 30 in the present embodiment may be, for example, a 3D digital TV on which 2D video and 3D video can be viewed.

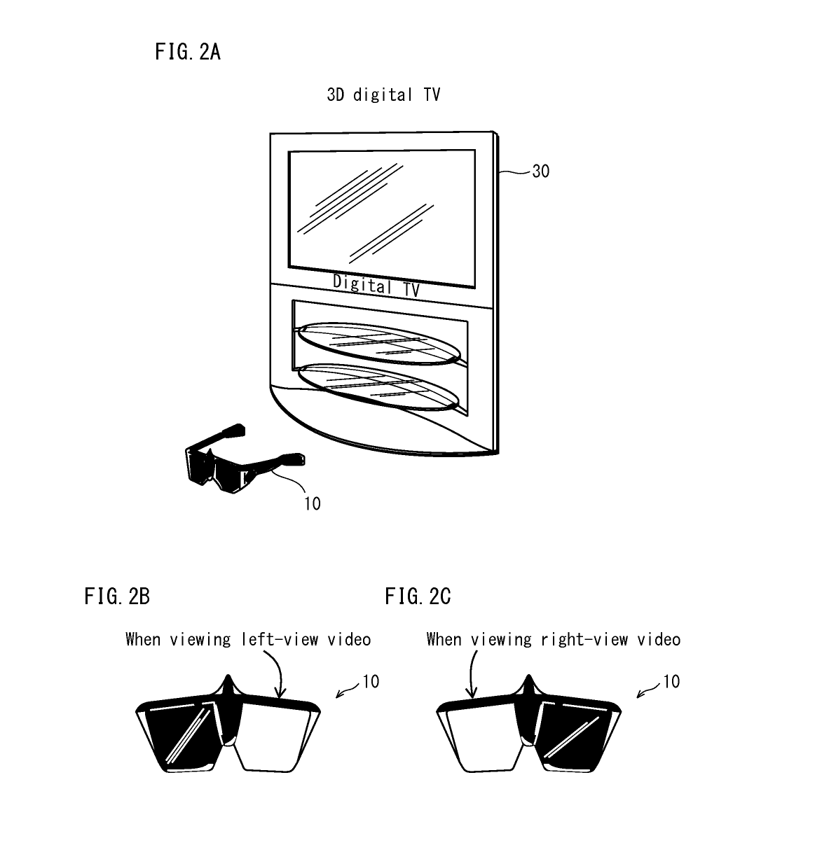

FIG. 2A illustrates the use form of the playback device (3D digital TV) 30. As illustrated in FIG. 2A, the user wears 3D glasses 10 when viewing 3D video on the playback device 30, wherein the 3D glasses 10 operate in cooperation with the playback device 30.

The 3D glasses 10 are provided with liquid crystal shutters and show parallax images to the user by the sequential segregation method. A parallax image refers to a set of an image for the right eye and an image for the left eye. Stereoscopic viewing is achieved by causing each of these images to be shown to the corresponding eye of the user.

FIG. 2B illustrates the state of the 3D glasses 10 when a left-eye video image is displayed (when a left-view video image is viewed). At the instant the left-eye video image is displayed on the screen, in the 3D glasses 10, the liquid-crystal shutter for the left eye is in the light transmission state, and the liquid-crystal shutter for the right eye is in the light block state.

FIG. 2C illustrates the state of the 3D glasses 10 when a right-eye video image is displayed. At the instant the right-eye video image is displayed on the screen, conversely to the above, the liquid-crystal shutter for the right eye is in the light transmission state, and the liquid-crystal shutter for the left eye is in the light block state.

Instead of outputting left and right pictures alternately along the time axis as in the above sequential segregation method, the playback device 30 may employ a different method that lines up a left-eye picture and a right-eye picture simultaneously in alternate rows within one screen. The picture passes through a hog-backed lens, referred to as lenticular lens, on the display screen. Pixels constituting the left-eye picture thus form an image for only the left eye, whereas pixels constituting the right-eye picture form an image for only the right eye, thereby showing the left and right eyes a parallax picture perceived as 3D. Note that usage is not limited to a lenticular lens. A device with a similar function, such as a liquid crystal element, may be used.

Another method for stereoscopic viewing is a polarization method in which a vertical polarization filter is provided for left-eye pixels, and a horizontal polarization filter is provided for right-eye pixels. The viewer looks at the display while wearing polarization glasses provided with a vertical polarization filter for the left eye and a horizontal polarization filter for the right eye.

Other than these methods for stereoscopic viewing using parallax images, many other techniques have been proposed, such as two-color separation methods. In the present example, the sequential segregation method is described, but usage of parallax images is not limited to this method.

This concludes the description of the use form of the playback device 30.

### <Stream Structure>

Next, the structure of a general stream transmitted by a digital television broadcast or the like is described.

In the data transfer using broadcast waves for digital TV, digital streams conforming to the MPEG-2 transport stream (TS) format are transferred. The MPEG-2 TS is a standard for transferring a stream in which various streams such as a video stream and an audio stream are multiplexed. The MPEG-2 TS has been standardized by the ISO/IEC13818-1 and the ITU-T Recommendation H222.0.

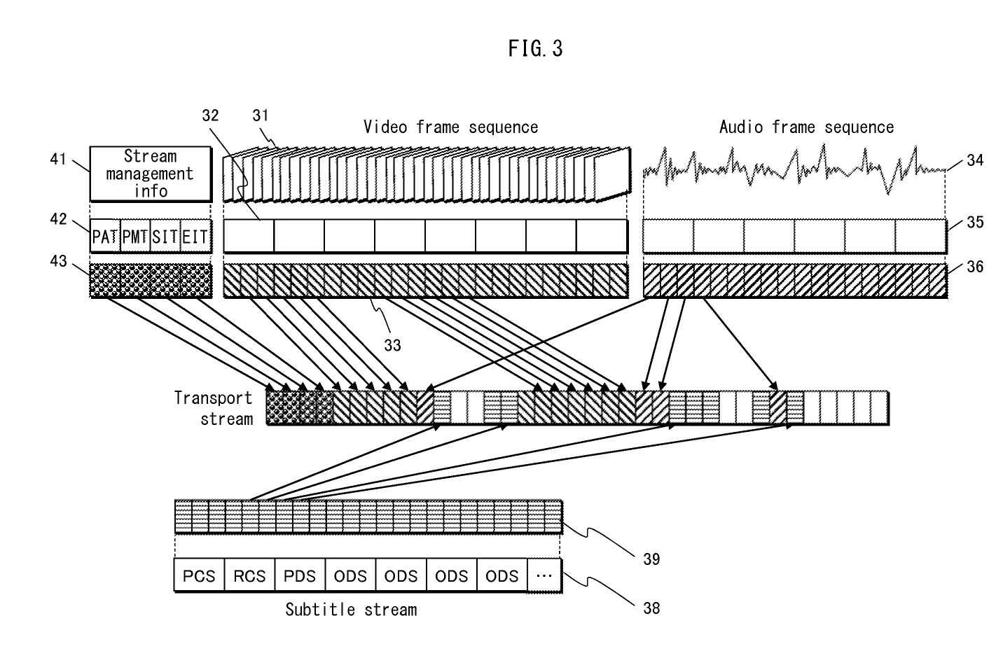

FIG. 3 illustrates the structure of a digital stream in the MPEG-2 TS format. As illustrated in FIG. 3, a transport stream is obtained by multiplexing a video stream, an audio stream, a subtitle stream, stream management information and the like. The video stream stores main video for a broadcast program. The audio stream stores primary and secondary audio for the broadcast program. The subtitle stream stores subtitle information for the broadcast program. The video stream is encoded by a video encoding method such as MPEG-2 or MPEG-4 AVC. The audio stream is compress-encoded with a method such as Dolby AC-3, MPEG-2 AAC, MPEG-4 AAC, HE-AAC, or the like.

As illustrated in FIG. 3, the video stream is obtained by converting a video frame sequence 31 into a PES packet sequence 32, and then into a TS packet sequence 33.

As illustrated in FIG. 3, the audio stream is obtained by subjecting an audio signal into quantization and sampling, converting the resultant audio signal into an audio frame sequence 34, then into a PES packet sequence 35, and then into a TS packet sequence 36.

As illustrated in FIG. 3, the subtitle stream is obtained by converting a functional segment sequence 38, which is composed of a plurality of types of segments such as Page Composition Segment (PCS), Region Composition Segment (RCS), Pallet Define Segment (PDS), and Object Define Segment (ODS), into a TS packet sequence 39.

### <Stream Management Information>

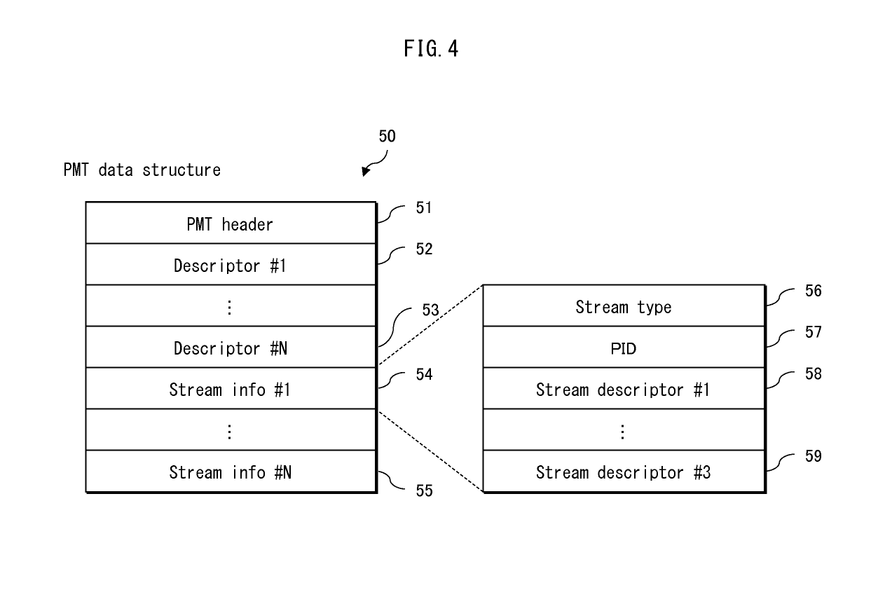

The stream management information is information that is stored in a system packet called PSI and is used to manage the video stream, audio stream, and subtitle stream multiplexed in the transport stream as one broadcast program. As illustrated in FIG. 4, the stream management information includes information such as PAT (Program Association Table), PMT (Program Map Table), EIT (Event Information Table), and SIT (Service Information Table).

The PAT indicates a PID of a PMT used in the transport stream, and is registered with the PID arrangement of the PAT itself. The PMT lists the PIDs of the video, audio, subtitle, and other streams included in the transport stream as well as attribute information on the streams corresponding to the PIDs. The PMT also lists descriptors related to the transport stream. The descriptors include copy control information indicating whether copying of the AV stream is permitted. The SIT contains information defined in accordance with the standards for the broadcast waves by using areas that can be defined by the user in accordance with the MPEG-2 TS standard. The EIT contains information concerning broadcast programs such as names, broadcast dates/times, and contents of the broadcast programs. The specific format of the above information is described in http:www.arib.or.jp/english/html/overview/do c/4-TR-B14v4_{—}4-2p3.pdf published by ARIB (Association of Radio Industries and Businesses).

FIG. 4 illustrates the data structure of the PMT in detail. A PMT 50 includes a PMT header 51 at the head thereof. The PMT header 51 stores information such as the length of data contained in the PMT 50. The PMT header 51 is followed by a plurality of descriptors 52, . . . , 53 related to the transport stream. The descriptors 52, . . . , 53 store information such as the above-described copy control information. The descriptors 52, . . . , 53 are followed by a plurality of pieces of stream information 54, . . . 55 related to the streams contained in the transport stream. Each piece of stream information pertaining to each stream includes: a stream type 56 for identifying the compression codec of the stream and the like; a PID 57 of the stream; and a plurality of stream descriptors 58, . . . 59 in which attribute information of the stream (frame rate, aspect ratio, etc.) is described.

### <Video Stream>

The video stream of the present embodiment is generated by performing a compress-encoding by a video compress-encoding method such as MPEG-2, MPEG-4 AVC, or SMPTE VC-1. These video compress-encoding methods utilize spatial and time redundancy in video in order to compress the amount of data. One method that takes advantage of the time redundancy of the video is inter-picture predictive encoding. According to the inter-picture predictive encoding, when a certain picture is encoded, another picture, which is before or after the certain picture in the order of presentation times, is referenced (the referenced picture is called a reference picture). Subsequently, an amount of motion from the reference picture is detected, and the spatial redundancy is removed from a difference between a motion-compensated picture and an encoding-target picture, thereby compressing the data amount.

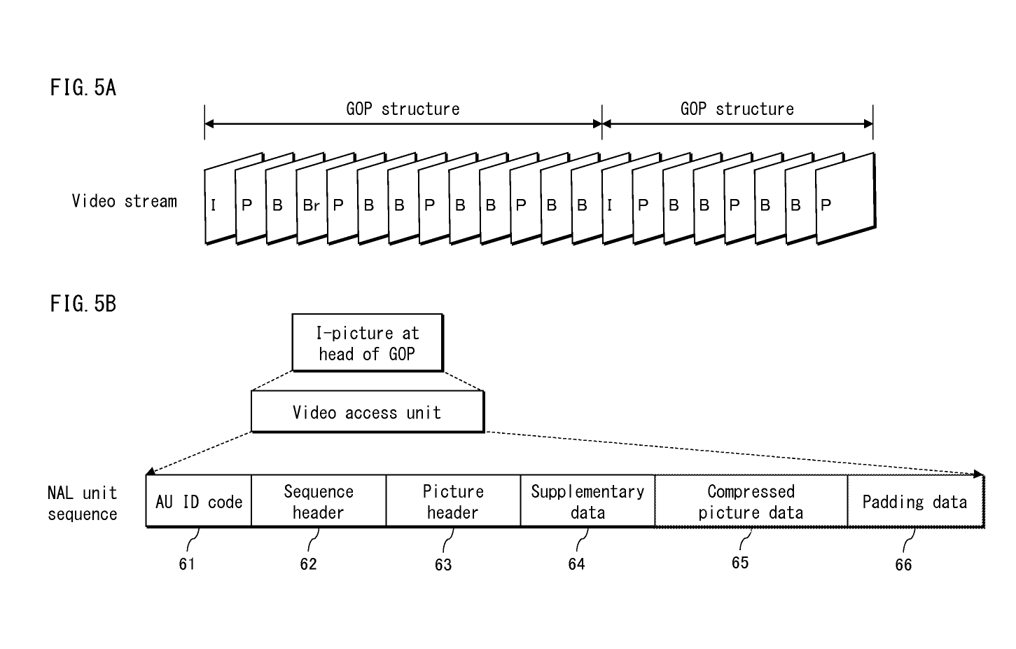

The video streams having been encoded by the above-described encoding methods have in common the GOP structure illustrated in FIG. 5A. A video stream is composed of a plurality of Groups of Pictures (GOP). Using GOPs as the basic unit of encoding allows for video images to be edited or randomly accessed. A GOP is composed of one or more video access units.

### <GOP>

FIG. 5A illustrates one example of GOP. As illustrated in FIG. 5A, the GOP is composed of a plurality of types of picture data which include I-picture, P-picture, B-picture, and Br-picture.

Among the pictures contained in the GOP, a picture that does not have a reference picture but is simply encoded by the intra-picture predictive encoding is called Intra-picture (I-picture). It should be noted here that “picture” is a unit of encoding encompassing both frame and field. A picture that is encoded by the inter-picture predictive encoding by referencing an already processed picture is called a P-picture. A picture that is encoded by the inter-picture predictive encoding by referencing two already processed pictures at the same time is called a B-picture. Among B-pictures, a picture that is referenced by another picture is called a Br-picture. Also, a frame in the case of the frame structure and a field in the case of the field structure are called video access units.

A video access unit is a unit of storage of compress-encoded data of picture, storing one frame in the case of the frame structure, and one field in the case of the field structure. The picture at the head of each GOP is an I-picture. To avoid redundant explanation that would be given if both MPEG-4 AVC and MPEG-2 were explained, the following description assumes that the compress-encoding method performed on the video stream is MPEG-4 AVC, unless it is explicitly stated otherwise.

FIG. 5B illustrates the internal structure of the video access unit that is the I-picture at the head of the GOP. The video access unit at the head of the GOP is composed of a plurality of Network Abstraction Layer (NAL) units. As illustrated in FIG. 5B, the video access unit at the head of the GOP includes NAL units: an AU ID code 61; a sequence header 62; a picture header 63; supplementary data 64; compressed picture data 65; and padding data 66.

The AU ID code 61 is a code indicating the head of the video access unit. The sequence header 62 stores information that is common through the whole playback sequence composed of a plurality of video access units. The common information includes resolution, frame rate, aspect ratio, and bit rate. The picture header 63 stores information such as an encoding method through the whole picture. The supplementary data 64 is additional information not indispensable for decompression of compressed data, and stores text information of closed caption to be displayed on TV in synchronization with the video, information on the GOP structure, and the like. The compressed picture data 65 stores data of compress-encoded pictures. The padding data stores meaningless data for maintaining the format. For example, the padding data is used as stuffing data for keeping a predetermined bit rate.

The data structures of the AU ID code 61, sequence header 62, picture header 63, supplementary data 64, compressed picture data 65, and padding data 66 are different depending on the video encoding method.

In the case of the MPEG-4 AVC, the AU ID code 61 corresponds to the AU delimiter (Access Unit Delimiter), the sequence header 62 to the SPS (Sequence Parameter Set), the picture header 63 to the PPS (Picture Parameter Set), the supplementary data 64 to the SEI (Supplemental Enhancement Information), the compressed picture data 65 to a plurality of slices, and the padding data 66 to the FillerData.

Also, in the case of the MPEG-2, the sequence header 62 corresponds to the sequence_Header, sequence_extension, group_of_picture_header, the picture_header 63 to the picture_header, picture_coding_extension, the supplementary data 64 to the user data, and the compressed picture data 65 to a plurality of slices. Although there is no counterpart to the AU ID code 61, it is possible to determine a boundary between access units by using the start code of each header. Each stream included in the transport stream is identified by a stream ID called PID. It is possible for the decoder to extract a processing target stream by extracting packets having the same PID. The correspondence between PIDs and streams is stored in the descriptor of a PMT packet as described below.

### <PES>

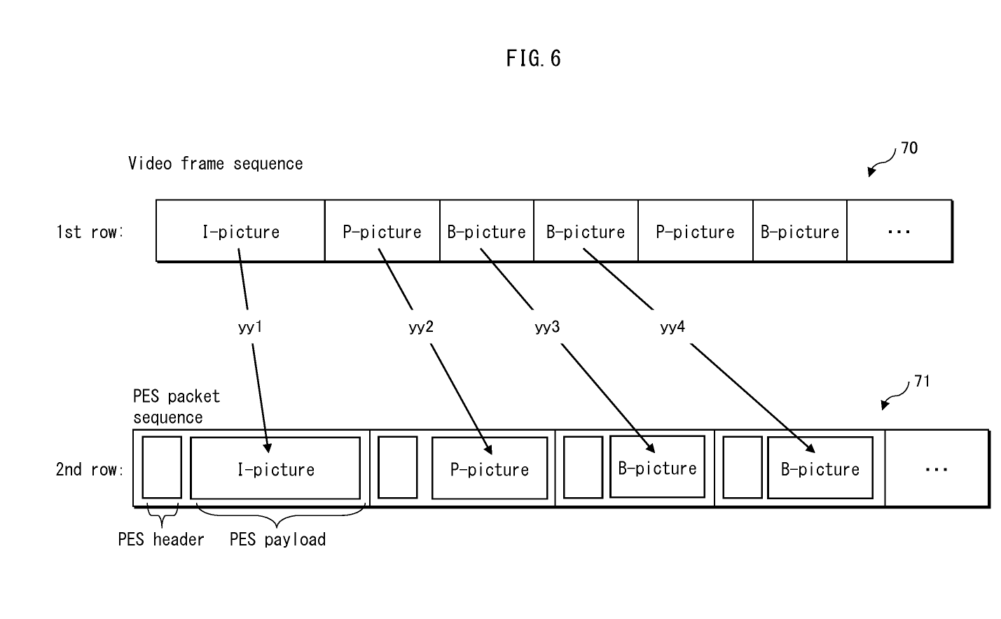

FIG. 6 is a diagram illustrating the process of converting pictures into PES packets.

Each picture is stored in a payload of a PES (Packetized Elementary Stream) packet through the conversion illustrated in FIG. 6.

The first row of FIG. 6 indicates a video frame sequence 70 of the video stream. The second row of FIG. 6 indicates a PES packet sequence 71. As indicated by arrows yy1, yy2, yy3 and yy4 in FIG. 6, the I-pictures, B-pictures and P-pictures, which are a plurality of video presentation units in the video stream, are separated from each other and stored in the payloads of the PES packets. Each PES packet has a PES header in which a PTS (Presentation Time Stamp), which indicates the presentation time of the picture, and a DTS (Decoding Time Stamp), which indicates the decoding time of the picture, are stored.

The PES packets converted from the pictures are each divided into a plurality of portions, and the divided portions are respectively stored in the payloads of the TS packets.

### <TS Packet>

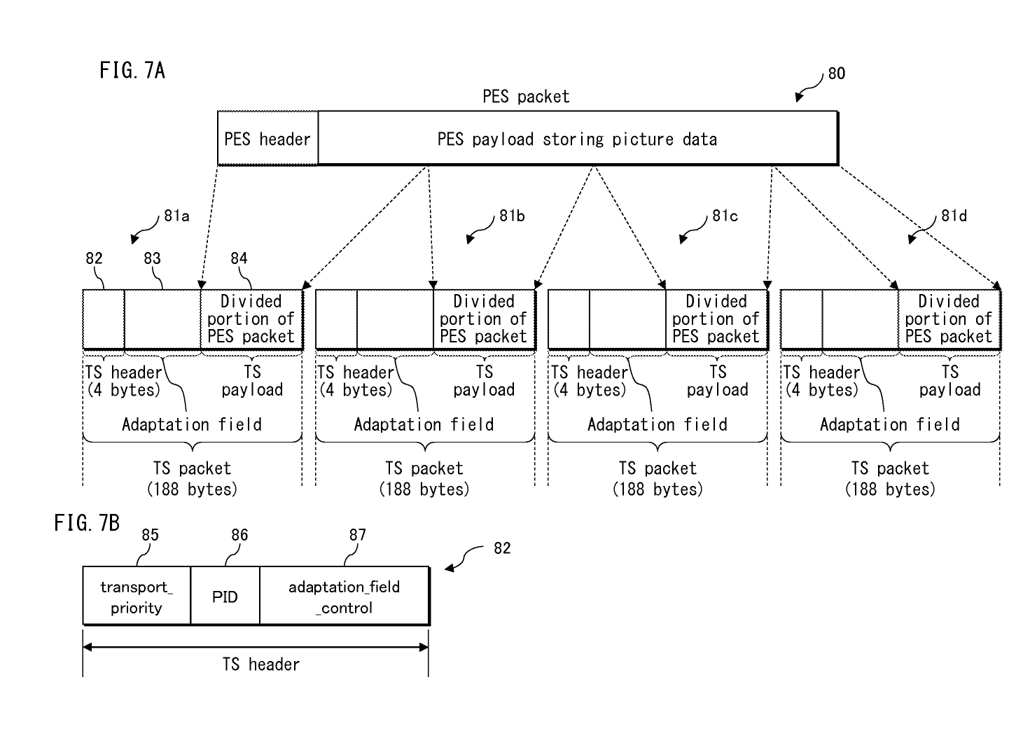

FIG. 7A illustrates the data structure of TS packets 81a, 81b, 81c, 81d that constitute a transport stream. The TS packets 81a, 81b, 81c, 81d have the same data structure. The following describes the data structure of the TS packet 81a. The TS packet 81a is a packet having a fixed length of 188 bytes and includes a TS header 82 of four bytes, an adaptation field 83, and a TS payload 84. As illustrated in FIG. 7B, the TS header 82 is composed of a transport_priority 85, a PID 86, and an adaptation_field_control 87.

The PID 86 is an ID identifying a stream multiplexed in the transport stream, as described above.

The transport_priority 85 is information for identifying a type of a packet in TS packets having the same PID.

Note that all of these elements may not necessarily be provided. There is a case where either the adaptation field or the TS payload is present, and a case where both of the adaptation field and the TS payload are present. The adaptation_field_control 87 indicates whether or not the adaptation field 83 and/or the TS payload 84 is present. When the adaptation_field_control 87 has a value “1”, it indicates that only the TS payload 84 is present; when the adaptation_field_control 87 has a value “2”, it indicates that only the adaptation field 83 is present; and when the adaptation_field_control has a value “3”, it indicates that both of the adaptation field 83 and the TS payload 84 are present.

The adaptation field 83 is a storage area for information such as a PCR and for data for stuffing the TS packet to reach the fixed length of 188 bytes. The TS payload 84 stores a divided portion of a PES packet.

As described above, the pictures are converted into PES packets, then into TS packets, and finally into a transport stream. The parameters constituting each picture are converted into NAL units.

The transport stream includes TS packets constituting the PAT, PMT, PCR (Program Clock Reference) and the like, as well as the TS packets constituting video, audio, and subtitle streams. These packets are called PSI described above. Here, the PID of a TS packet containing a PAT is “0”. Each PCR packet has information of an STC (System Time Clock) time corresponding to a time at which the PCR packet is transferred to the decoder, so that a time at which a TS packet arrives at the decoder can be synchronized with the STC which is a time axis of PTS and DTS.

This concludes the description of the general structure of a stream for a digital television broadcast or the like.

### <Parallax Image>

Next, the general video format for achieving parallax images used in stereoscopic viewing is described.

In a method for stereoscopic viewing using parallax images, images to be presented to the right eye and images to be presented to the left eye are prepared, and stereoscopic viewing is achieved by presenting corresponding pictures to each eye.

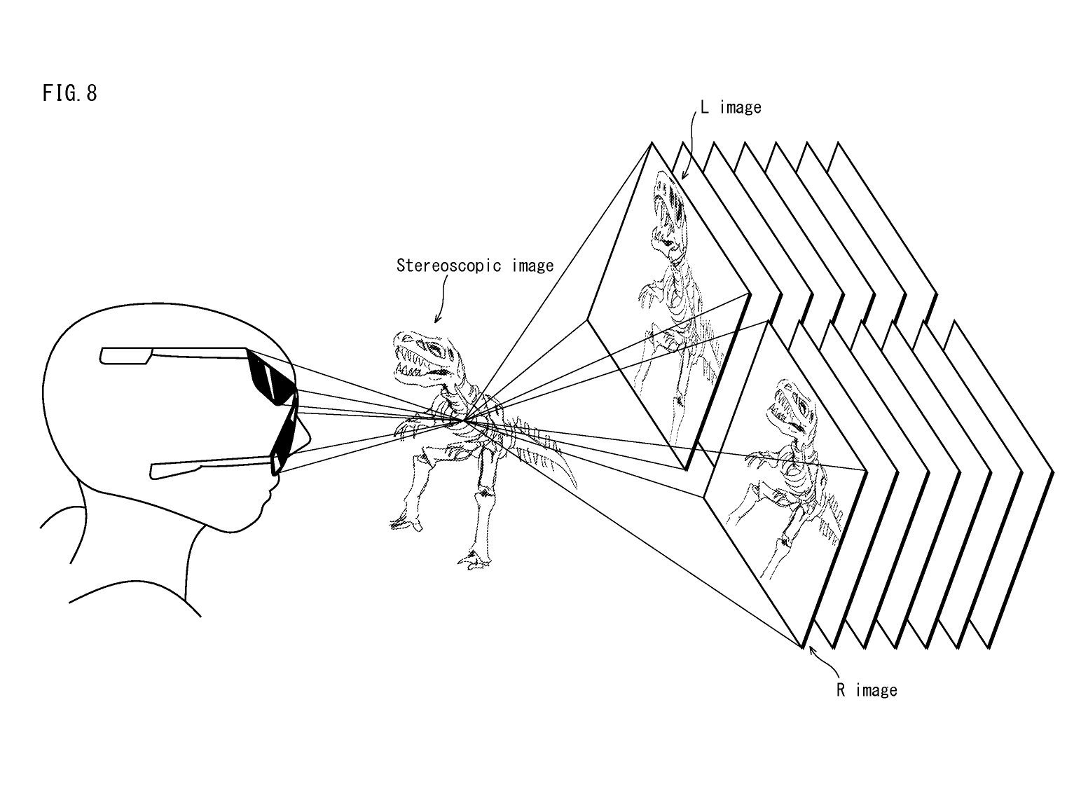

FIG. 8 illustrates an example case where the user on the left-hand side is viewing an image of a dinosaur skeleton stereoscopically with a left-eye image and a right-eye image thereof illustrated on the right-hand side.

The 3D glasses are used to transmit and block light to the right and left eyes repeatedly. This allows for left and right scenes to be overlaid within the viewer's brain due to the afterimage phenomenon of the eyes, causing the viewer to perceive a stereoscopic image as existing along a line extending from the user's face.

Between the parallax images, the image to be presented to the left eye is referred to as a left-eye image (L image), and the image to be presented to the right eye is referred to as a right-eye image (R image). Furthermore, a video composed of pictures that are L images is referred to as a left-view video (left-eye video), and a video composed of pictures that are R images is referred to as a right-view video (right-eye video).

The 3D video methods for compress-encoding the left-view and right-view videos include the frame compatible method and the multi-view encoding method.

### <Frame Compatible Method>

According to the frame compatible method, pictures corresponding to images of the same time in the left-view and right-view videos are thinned out or reduced and then combined into one picture, and the combined picture is compress-encoded by a typical compress-encoding method.

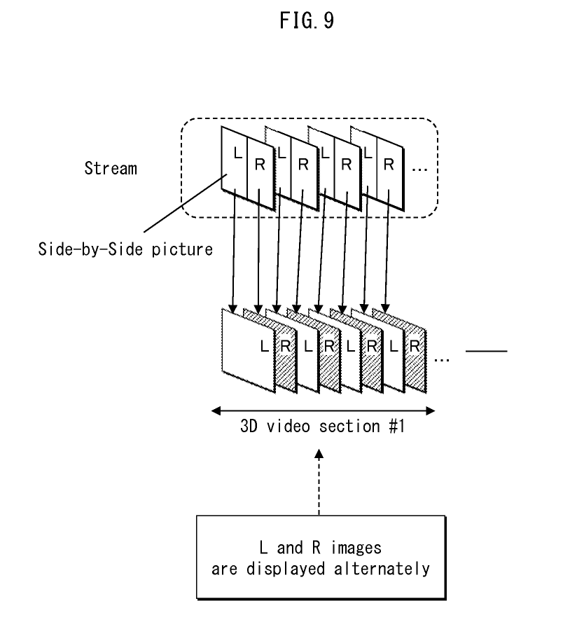

As an example of the frame compatible method, FIG. 9 illustrates the Side-by-Side method. According to the Side-by-Side method, the pictures corresponding to images of the same time in the left-view and right-view videos are each reduced to ½ in size horizontally, and are arranged in parallel horizontally to be combined into one picture. A video composed of the combined pictures is compress-encoded by a typical compress-encoding method into a stream. On the other hand, when video is played back, the stream is decoded by the typical compress-encoding method into the video. The decoded pictures of the video are divided into left and right images, and the left and right images are extended double in size horizontally, thereby pictures corresponding to the left-view and right-view videos are obtained. The stereoscopic image as illustrated in FIG. 8 is realized when the obtained pictures for the left-view and right-view videos (L image and R image) are alternately displayed.

The frame compatible method includes the Top and Bottom method and the Line Alternative method, as well as the Side-by-Side method. According to the Top and Bottom method, the left-eye and right-eye images are arranged vertically. According to the Line Alternative method, the left-eye and right-eye images are arranged alternately per line in the picture.

### <Multi-View Encoding Method>

Next, the multiview encoding method is described. One example of the multiview encoding method is the MPEG-4 MVC (Multiview Video Coding) revised from the MPEG-4 AVC/H.264 standard. The MPEG-4 MVC is an encoding method for compressing 3D video with high efficiency. The Joint Video Team (JVT), a joint project between ISO/IEC MPEG and ITU-T VCEG, completed the revised MPEG-4 AVC/H.264 standard, referred to as Multiview Video Coding (MVC), in July of 2008.

In the multiview encoding method, the left-view video and the right-view video are digitized and then compress-encoded to obtain video streams.

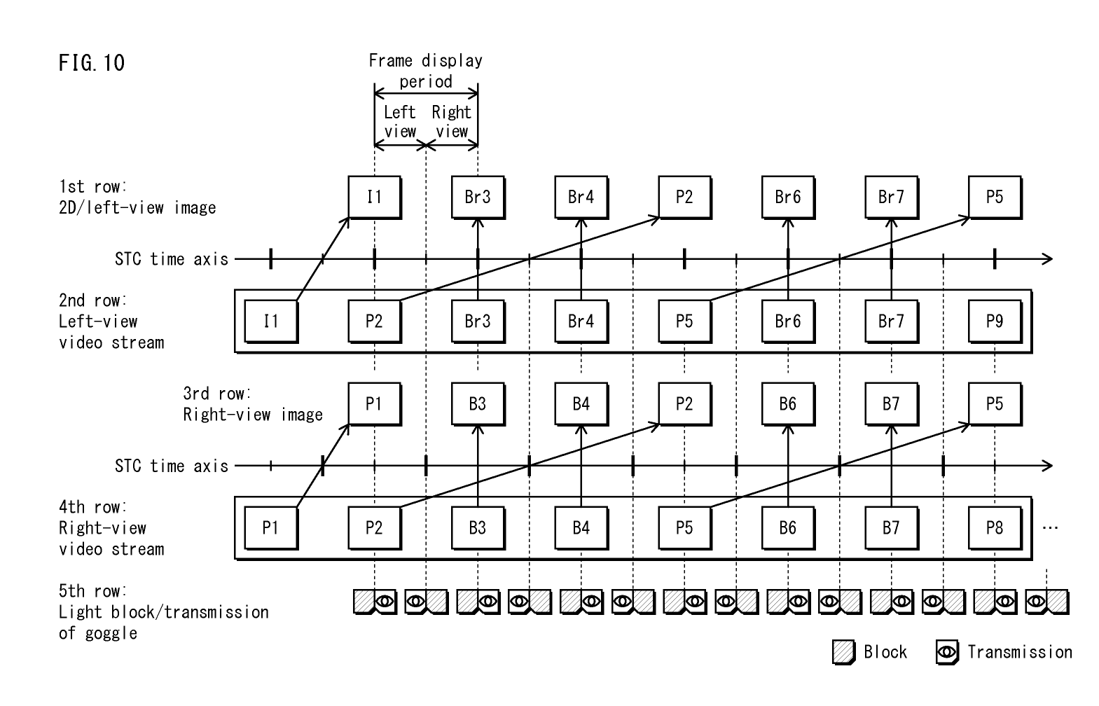

FIG. 10 illustrates an example of the internal structure of a left-view video stream and a right-view video stream for stereoscopic viewing by the multiview encoding method.

The second row of FIG. 10 illustrates the internal structure of the left-view video stream. This stream includes pictures such as I1, P2, Br3, Br4, P5, Br6, Br7, and P9. These pictures are decoded in accordance with the DTS (Decode Time Stamp).

The first row of FIG. 15 illustrates left-eye images. The left-eye images are displayed by displaying the decoded pictures I1, P2, Br3, Br4, P5, Br6, Br7, and P9 in the order of the time set in the PTS, namely, in the order of I1, Br3, Br4, P2, Br6, Br7, and P5. In FIG. 10, a picture that does not have a reference picture but is simply encoded by the intra-picture predictive encoding is called an I-picture. It should be noted here that “picture” is a unit of encoding encompassing both frame and field. A picture that is encoded by inter-picture predictive encoding by referring to an already processed picture is called a P picture. A picture that is encoded by inter-picture predictive encoding by referring to two already processed pictures at the same time is called a B picture. Among B pictures, a picture that is referred to by another picture is called a Br picture.

The fourth row of FIG. 10 illustrates the internal structure of the right-view video stream. This right-view video stream includes pictures P1, P2, B3, B4, P5, B6, B7, and P8. These pictures are decoded in accordance with the DTS. The third row illustrates right-eye images. The right-eye images are displayed by displaying the decoded pictures P1, P2, B3, B4, P5, B6, B7 and P8 in the order of the time set in the PTS, namely, in the order of P1, B3, B4, P2, B6, B7 and P5. It should be noted here that, in the stereoscopic playback according to the sequential segregation method, either of a left-eye image and a right-eye image whose PTSs have the same value of time is displayed with a delay of half the interval between times of two consecutive PTSs (hereinafter referred to as “3D presentation delay”).

The fifth row illustrates how the state of the 3D glasses 10 changes. As illustrated in the fifth row, when the left-eye image is viewed, the shutter for the right eye is closed, and when the right-eye image is viewed, the shutter for the left eye is closed.

The left-view video stream and the right-view video stream are compressed not only with inter-picture predictive encoding that uses a temporal correlation, but also with inter-picture predictive encoding that uses a correlation between view points. Pictures in the right-view video stream are compressed with reference to pictures having the same presentation time in the left-view video stream.

For example, the starting P-picture of the right-view video stream references an I-picture of the left-view video stream, a B-picture of the right-view video stream references a Br-picture of the left-view video stream, and the second P-picture of the right-view video stream references a P-picture of the left-view video stream.

Between the compress-encoded left-view and right-view video streams, a video stream that can be decoded by itself is referred to as “base-view video stream”. Furthermore, between the left-view video stream and the right-view video stream, a video stream that is compress-encoded based on the inter-frame correlation, between views, with the pictures constituting the base-view video stream, and that can be decoded only after decoding the base-view video stream, is referred to as “dependent-view video stream”. A combination of the base-view video stream and the dependent-view video stream is referred to as a “multi-view video stream”. The base-view video stream and the dependent-view video stream may be stored and transmitted as separate streams, or may be multiplexed into one stream conforming to, for example, MPEG-2 TS.

### <Relationship Between Access Units of Base-View Video Stream and Dependent-View Video Stream>

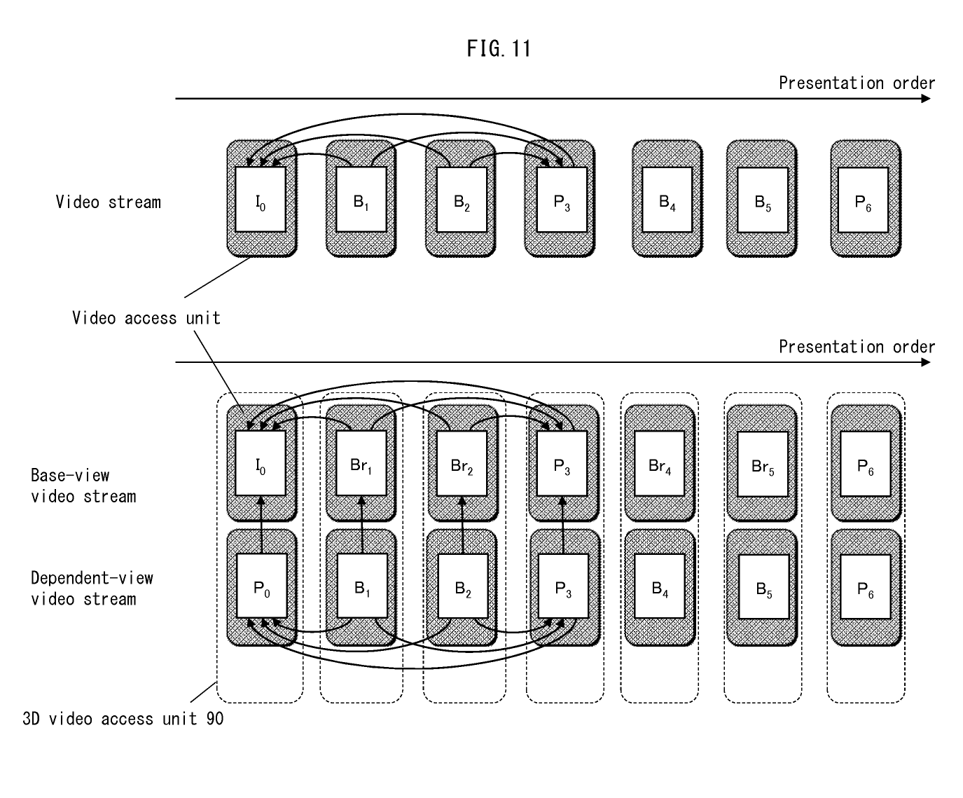

FIG. 11 illustrates the structure of the video access units of the pictures included in the base-view video stream and the dependent-view video stream. As described above, each picture of the base-view video stream functions as a video access unit, as illustrated in the upper portion of FIG. 11. Similarly each picture of the dependent-view video stream functions as a video access unit, as illustrated in the lower portion of FIG. 11, but has a different data structure. Furthermore, as illustrated in the lower portion of FIG. 11, a video access unit of the base-view video stream and a video access unit of the dependent-view video stream that have the same presentation time form a 3D video access unit 90. A video decoder, described below, decodes and displays images in units of 3D video access units. Note that in the MPEG-4 MVC video codec, each picture (in this context, a video access unit) in one view is defined as a “view component”, and a set of pictures with the same presentation time in multi-view (in this context, a 3D video access unit) is defined as an “access unit”. In the present embodiment, the terms defined with reference to FIG. 11 are used.

### <PTS and DTS>

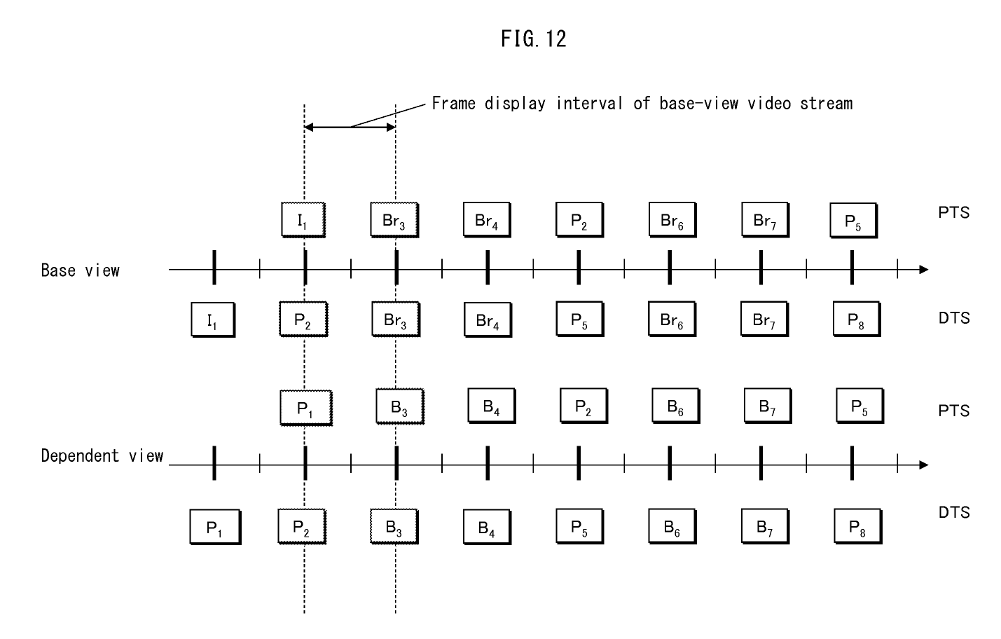

FIG. 12 illustrates an example of the relationship between the presentation time (PTS) and the decode time (DTS) allocated to each video access unit in the base-view video stream and the dependent-view video stream within the AV stream.

A picture in the base-view video stream and a picture in the dependent-view video stream that store parallax images for the same presentation time are set to have the same DTS/PTS. This is achieved by setting the decoding/presentation order of the base-view picture and the dependent-view picture, which are in a reference relationship for inter-picture predictive encoding, to be the same. With this structure, a video decoder, which decodes pictures in the base-view video stream and pictures in the dependent-view video stream, can decode and display images in units of 3D video access units.

### <GOP Structure of Base-View Video Stream and Dependent-View Video Stream>

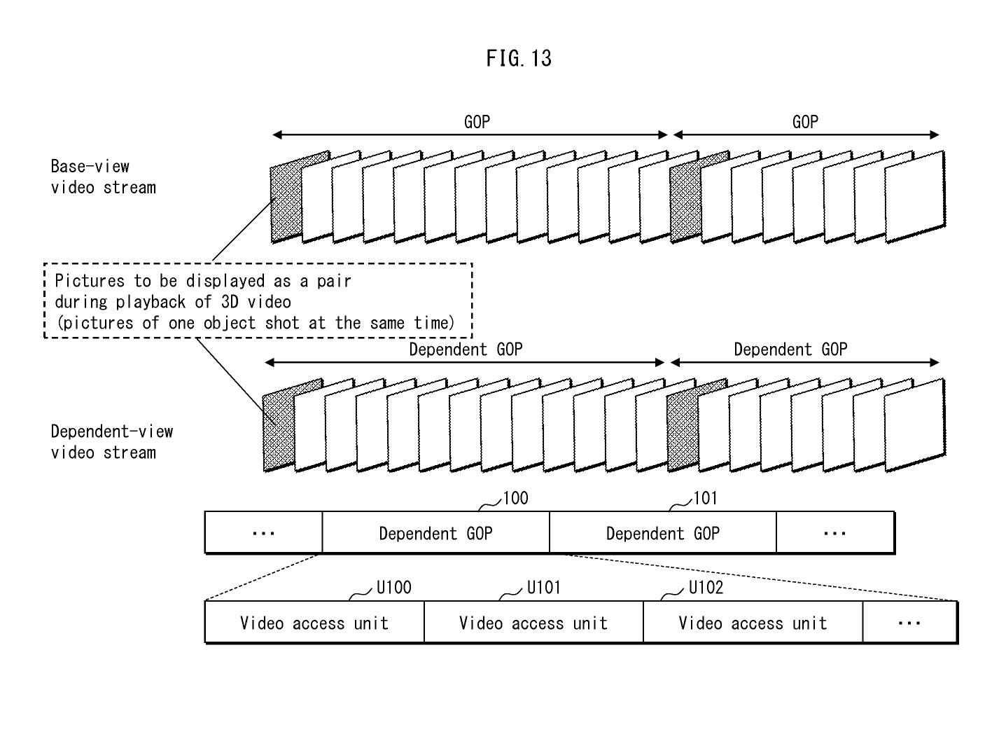

FIG. 13 illustrates the GOP structure of the base-view video stream and the dependent-view video stream. The GOP structure of the base-view video stream is the same as the structure of a conventional video stream and is composed of a plurality of video access units. The dependent-view video stream is, similar to a conventional video stream, composed of a plurality of dependent GOPs 100, 101, . . . . Each dependent GOP is composed of a plurality of video access units U100, U101, U102, . . . . The starting picture of each dependent GOP is a picture displayed as a pair with the I-picture at the start of a GOP of the base-view video stream when the 3D video is played back. The same PTS is assigned to the starting picture of the dependent GOP and the I-picture of the paired GOP of the base-view video stream.

### <Video Access Unit Included in Dependent GOP>

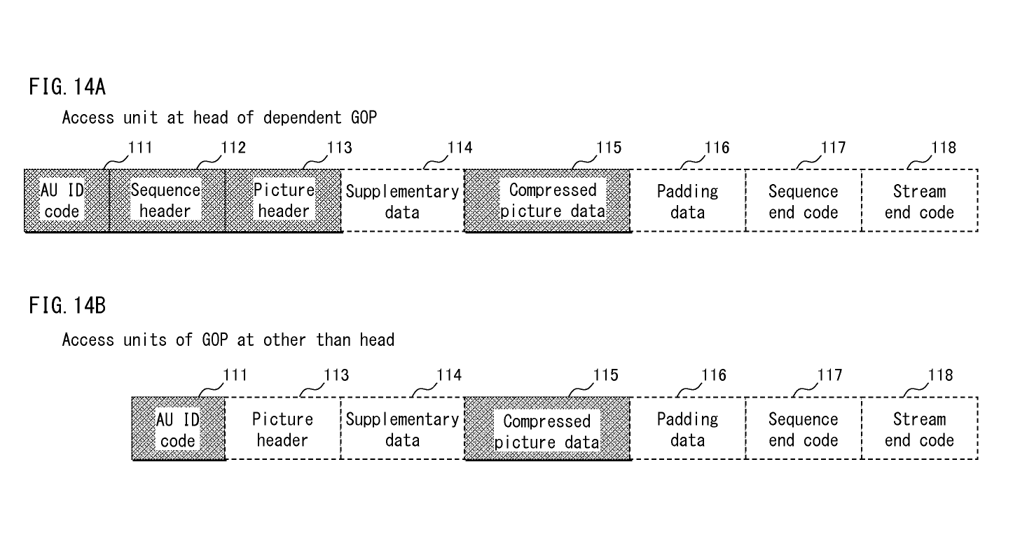

FIGS. 14A and 14B illustrate the structure of the video access units included in the dependent GOP. As illustrated in FIGS. 14A and 14B, the video access unit includes: an AU ID code 111; a sequence header 112; a picture header 113; supplementary data 114; compressed picture data 115; padding data 116; sequence end code 117; and stream end code 118. The AU ID code 111, as the AU ID code 61 illustrated in FIG. 4, stores a start code that indicates the head of the access unit. The sequence header 112, picture header 113, supplementary data 114, compressed picture data 115, and padding data 116 are the same as the sequence header 62, picture header 63, supplementary data 64, compressed picture data 65, and padding data 66 illustrated in FIG. 4, and description thereof is omitted here. The sequence end code 117 stores data that indicates the end of a playback sequence. The stream end code 118 stores data that indicates the end of a bitstream.

As illustrated in FIG. 14A, in the video access unit located at the head of the dependent GOP, the compressed picture data 115 stores, without fail, data of a picture that is to be displayed at the same time as the I-picture located at the head of the GOP of the base-view video stream, and the AU ID code 111, sequence header 112 and picture header 113 store data as well without fail. The supplementary data 114, padding data 116, sequence end code 117 and stream end code 118 may or may not store data. The values of the frame rate, resolution and aspect ratio in the sequence header 112 are the same as the frame rate, resolution and aspect ratio of the sequence header included in the video access unit at the head of the corresponding GOP of the base-view video stream. As illustrated in FIG. 14B, in the video access unit located at other than the head of the dependent GOP, the AU ID code 111 and the compressed picture data 115 store data without fail. The picture header 113, supplementary data 114, padding data 116, sequence end code 117 and stream end code 118 may or may not store data.

This concludes the description of the general video format for achieving parallax images used in stereoscopic viewing.

### <Realtime Playback of Hybrid 3D Broadcast>

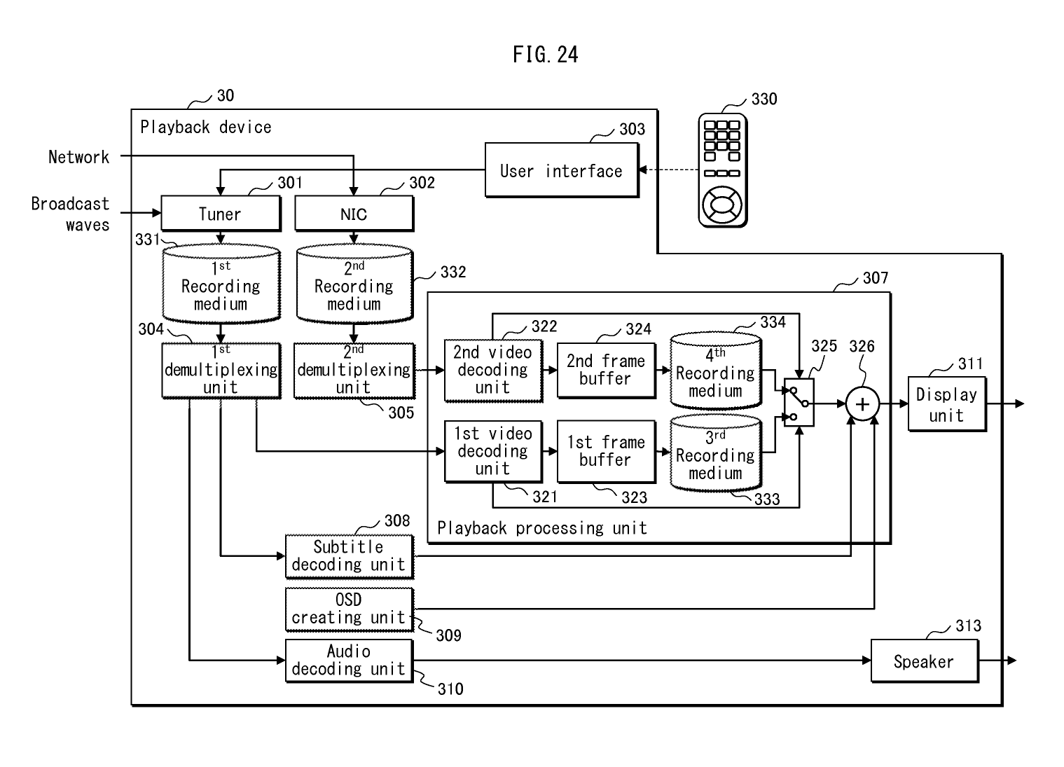

In the above-described embodiment, the right-eye video is stored in advance for the hybrid 3D broadcast to be realized. The following describes the structure of the playback device 30 that receives the right-eye video in real time, without storing it in advance, with reference to FIG. 24, centering on the difference from the structure of the playback device 30 described with reference to FIG. 18.

The playback device 30 of the present supplementary explanation illustrated in FIG. 24 differs from the playback device 30 illustrated in FIG. 18 in that it includes a first recording medium 331, a third recording medium 333, and a fourth recording medium 334. A second recording medium 332 illustrated in FIG. 24 and the recording medium 312 illustrated in FIG. 18 are substantially the same, except for the names.

The reason for providing the third recording medium 333 and the fourth recording medium 334 is that it is necessary to absorb various types of delays that would occur between a transmission of hybrid 3D broadcast waves and a reception and playback thereof. The third recording medium 333 and the fourth recording medium 334 are each composed of a semiconductor memory or the like that can read and write at high speeds.

Here, “tbs” denotes a time at which a TS packet including the starting data of the video specifying a predetermined time (PTS) is transmitted as broadcast waves; “tbr” denotes a time at which the tuner 301 receives the TS packet; “tis” denotes a time at which a TS packet including the starting data of the right-eye video of the same time as the PTS is transmitted via the network, and “tir” denotes a time at which the NIC 302 receives data.

When the transmission device 20 starts transmitting the left-eye video and the right-eye video at the same time, the values of “tbs” and “tis” are different since the time required for transmitting the video via the broadcast waves is different from the time required for transmitting the video via the network. Also, the time required for the video to reach the receiver via the broadcast waves is different from the time required for the video to reach the receiver via the network. For this reason, the values of “tbr” and “tir” are different.

The third recording medium 333 and the fourth recording medium 334 are provided as buffers for absorbing the difference (hereinafter referred to as “transmission delay”) between the values of “tbr” and “tir”.

Note that, although in the present supplementary explanation, the third recording medium 333 and the fourth recording medium 334 are provided as individual recording mediums, they may be provided as one recording medium if the data writing and reading speeds are high enough for the data writing error or reading error to be prevented.

The first recording medium 331 and the second recording medium 332 function as receiving buffers. That is to say, when the hybrid 3D broadcast is received, the first recording medium 331 and the second recording medium 332 temporarily store a predetermined amount of data. Here, the predetermined amount means, for example, an amount of data that corresponds to video images of 10 seconds, or an amount (for example, 100 MB) that is determined from the capacity of the recording medium.

The first recording medium 331 and the second recording medium 332 can be used for recording the hybrid 3D broadcast. The recording of the hybrid 3D broadcast can reduce the capacity of the third recording medium 333 and the fourth recording medium 334 for compensating the transmission delay.

The reduction in the capacity of the third recording medium 333 and the fourth recording medium 334 brings advantages in terms of the cost as follows.

That is to say, the data to be recorded in the first recording medium 331 and the second recording medium 332 is the TS, and the video ES contained in the TS has been compressed, and thus the transfer rate thereof in writing and reading is relatively low. There is no problem in using a recording medium such as the HDD (Hard Disk Drive) that is low in price per unit capacity, as the first recording medium 331 and the second recording medium 332.

On the other hand, the data to be recorded in the third recording medium 333 and the fourth recording medium 334 is decoded video frames transferred from the first frame buffer 323 and the second frame buffer 324, which have not been compressed. Thus, due to the necessity of transferring a large amount of uncompressed data in a short period, a recording medium, such as the semiconductor memory, that is high in transfer rate in writing and reading and high in price per unit capacity has to be used as the third recording medium 333 and the fourth recording medium 334. Accordingly, the reduction in the capacity of the third recording medium 333 and the fourth recording medium 334 brings advantages in terms of the cost.

With this structure, the data transfer is performed as follows. For example, the capacity of the fourth recording medium 334 is determined as a capacity for storing three frames. Then, a control is made so that when the number of frames stored in the fourth recording medium becomes less than three, the data stored in the second recording medium 332 is output to the second demultiplexing unit 305, so that the fourth recording medium 334 always stores three picture frames. The third recording medium 333 and the first recording medium 331 are processed in a similar manner With this structure, unless the data recorded in the first recording medium 331 and the second recording medium 332 is exhausted, the data recorded in the third recording medium 333 and the fourth recording medium 334 is not exhausted, either. This structure allows for the transmission delays to be absorbed effectively.

Furthermore, the TS to be recorded in the first recording medium 331 is received via broadcast waves. Thus as far as the reception conditions are excellent, the TS transmitted from the broadcasting station can be recorded assuredly. On the other hand, the TS to be recorded in the second recording medium 332 is received via the network. Thus the TS may not be received assuredly if, for example, the network is in the overload conditions.

When the TS cannot be received well via the network, the data to be supplied to the second video decoding unit 322 via the second recording medium 332 and the second demultiplexing unit 305 may be exhausted. To avoid the exhaust of the data, the playback device 30 may detect whether or not the data recorded in the second recording medium 332 is likely to be exhausted, and when having detected that the data is likely to be exhausted, may request the transmission device 20 to transmit a TS that has a lower bit rate.

Also, the minimum capacity of the first recording medium 331 and the second recording medium 332 may be determined based on a capacity that is calculated by multiplying a delay time assumed between the broadcast waves and the network by the transfer rate of a TS that reaches earlier between a TS transferred via broadcast waves and a TS transferred via the network, and adding an allowance as necessary. As the allowance, for example, one second may be added without fail to an assumed delay time when the capacity is determined. Alternatively, a time of a predetermined ratio (for example, 10%) of an assumed delay time may be added to the assumed delay time so that an amount corresponding to the predetermined ratio can be assured in the capacity.

### <Trick Play in Hybrid 3D Broadcast>

The following is a supplementary explanation of the trick play (for example, fast forward, rewind, frame-by-frame, or high-speed playback as 1.5 times speed, 2 times speed or 3 times speed playback) performed on a 3D video transmitted by the hybrid 3D broadcast.

The following description is provided on the premise that all or part of the broadcast program transmitted for a trick play by the hybrid 3D broadcast is stored in the first recording medium 331 and the second recording medium 332 illustrated in FIG. 24.

(1) In general, when a 2D broadcast program is recorded in a playback device and then a fast forward playback is performed on the recorded 2D broadcast program, positions of I-pictures and positions of TS packets including the heads of the I-pictures are recorded when the 2D broadcast program is recorded, and the fast forward playback is realized by reading, decoding and playing back only the I-pictures. In the case where an enough number of frames for the fast forward playback cannot be assured by decoding and playing back only the I-pictures, the fast forward playback may be performed by reading only the I-pictures and P-pictures.

It is assumed here that the fast forward playback is performed on the 3D video by reading only the I-pictures and P-pictures, as in the above-described case of the 2D video.

In that case, pairs of left-eye and right-eye video frames having the same scheduled presentation time are displayed at intervals of several frames. It should be noted here that the fast forward playback cannot be performed when, for example, in a pair for the same scheduled presentation time, the left-eye video frame is an I-picture and the right-eye video frame is a B-picture.

It is understood from the above that, in order for the fast forward playback to be realized on the hybrid 3D broadcast program recorded in a playback device, the video broadcast via broadcast waves and the video transmitted via a network need to correspond to each other in picture structure. As the method for causing the two types of videos to correspond to each other in picture structure, the following methods are considered.

(a) In many cases of the hybrid 3D broadcasting system, the left-eye video may be transmitted by using an existing 2D broadcast transmission system, and the right-eye video may be transmitted via a network by using a device that is newly added for that purpose. This is because in such a system, there is no need to greatly modify the existing 2D broadcast transmission system for the support of the hybrid 3D broadcast, thereby restricting the cost for the modification.

In the case of this system, the first video encoding unit 206 (corresponding to the existing 2D broadcast transmission system) of the transmission device 20 illustrated in FIG. 16 may notify the second video encoding unit 207 (corresponding to the new device) of the picture structure of the generated video frames, and the second video encoding unit 207 may generate video frames in conformance with the picture structure notified from the first video encoding unit 206, so that the left-eye video and the right-eye video correspond to each other in picture structure (when a picture of the left-eye video at a certain time is an I-picture, a picture of the right-eye video at the certain time is an I-picture or a P-picture, for example).

(b) Picture structure information indicating an encoding order of I-, P- and B-pictures is input to both the first video encoding unit 206 and the second video encoding unit 207. The first video encoding unit 206 and the second video encoding unit 207 operate in accordance with the picture structure information and output video elementary streams (ES), enabling the left-eye video and the right-eye video to correspond to each other in picture structure.

(2) A trick play such as the fast forward may be performed on a recorded hybrid 3D broadcast. When this is taken into account, it is desirable that the playback device 30 side can recognize whether or not the video ES received via broadcast waves and the video ES received via a network correspond to each other in picture structure.

As one example of the method for realizing this, the transmission device 20 may, for example, transmit an EIT that includes a flag indicating, in units of broadcast programs, whether or not the ESs correspond to each other in picture structure.

Furthermore, in the case where a plurality of channels (broadcasting channels) differ in picture structure, the above-described information may be included in an NIT (Network Information Table) or SIT that are information accompanying each of the channels.

(3) There may be a case where the left-eye video transmitted via broadcast waves conforms to MPEG-2 Video and the right-eye video transmitted via a network conforms to MPEG-4 AVC. The MPEG-2 Video is a relatively old compression technology and causes a light load of decoding process, while the MPEG-4 AVC causes a heavy load of decoding process.

In such a case, all frames conforming to the MPEG-2 Video may be decoded, and only I-pictures (and also P-pictures if necessary) may be selectively decoded with regard to the MPEG-4 AVC, and only the video frames conforming to the MPEG-2 Video having the same PTS time as the decoded pictures of the MPEG-4 AVC may be used in the fast forward.

In that case, if the playback device 30 records positions of the TS packets including the heads of the I-pictures (and also P-pictures if necessary) that conform to the MPEG-4 AVC when it records the video, the playback device 30 can perform the trick play easily.

(4) In the case where, among pictures conforming to the MPEG-2 Video and MPEG-4 AVC, pictures having the same PTS time are pictures having the same attribute (I-pictures), the transport_priority (see FIG. 7) contained in the TS packets that transport the pictures may be set to 1, and the transport_priority in the other TS packets may be set to 0. Then, when a hybrid 3D broadcast program is recorded and played back, the fast forward playback can be realized by selectively inputting only TS packets having transport_priority set to 1 into the first video decoding unit 321 and the second video decoding unit 322 via the first demultiplexing unit 304 and the second demultiplexing unit 305, respectively.

### INDUSTRIAL APPLICABILITY

The video playback device in one embodiment of the present invention can appropriately control whether to permit the passing playback for viewers to view video images stored in advance, and is useful as a device for playing back a 3D video that is stored in advance.

### REFERENCE SIGNS LIST

1000 video transmission/reception system
10 3D glasses
20 transmission device
30 playback device
201 video storage
202 stream management information storage
203 subtitle stream storage
204 audio stream storage
205 encoding processing unit
206 first video encoding unit
207 second video encoding unit
208 first multiplexing processing unit
209 second multiplexing processing unit
210 first TS storage
211 second TS storage
212 broadcasting unit
213 NIC
301 tuner
302 NIC
303 user interface
304 first demultiplexing unit
305 second demultiplexing unit
306 playback control unit
307 playback processing unit
308 subtitle decoding unit
309 OSD creating unit
310 audio decoding unit
311 display unit
312 recording medium
313 speaker
321 first video decoding unit
322 second video decoding unit
323 first frame buffer
324 second frame buffer
325 frame buffer switching unit
326 overlay unit
330 remote control

1. A video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback device comprising:
a storage storing the second view-point video;
a video receiving unit configured to receive the first view-point video over the broadcast waves;
an information obtaining unit configured to obtain inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback;
a playback unit configured to play back the second view-point video; and
a control unit configured to inhibit the second view-point video from being played back when the scheduled presentation time of a next video frame, which is a video frame to be displayed next, is later than current time and the inhibition/permission information indicates that displaying the next video frame is inhibited.

2. The video playback device of claim 1, wherein
the inhibition/permission information is transmitted over the broadcast waves, and
the information obtaining unit receives the broadcast waves and obtains the inhibition/permission information from the broadcast waves.

3. The video playback device of claim 1, wherein
the inhibition/permission information is stored in the storage, and
the information obtaining unit obtains the inhibition/permission information by reading the inhibition/permission information from the storage.

4. The video playback device of claim 1, wherein
the inhibition/permission information contains information indicating date and time at which use of the inhibition/permission information is to be started,
the information obtaining unit obtains the information indicating the date and time, and
the control unit inhibits the second view-point video from being played back when the date and time indicated by the obtained information is later than current time, even when the inhibition/permission information indicates that a display is permitted.

5. The video playback device of claim 1, wherein
the information obtaining unit further obtains date-and-time information that indicates date and time at which the second view-point video stored in the storage is to be deleted,
the video playback device further comprising
a deleting unit configured to delete the second view-point video stored in the storage when current time reaches the date and time indicated by the date-and-time information.

6. The video playback device of claim 1, wherein
each of a sequence of video frames constituting the first view-point video is assigned a scheduled display time that is set based on a first initial time,
each of a sequence of video frames constituting the second view-point video is assigned a scheduled display time that is set based on a second initial time that is different from the first initial time,
the information obtaining unit further obtains a difference time between the first initial time and the second initial time, and
the control unit uses, as the scheduled presentation time of the next video frame at which the next video frame is scheduled to be broadcast for the realtime playback, a time that is obtained by adding the difference time to a scheduled display time assigned to the next video frame.

7. A video playback method for use in a video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback method comprising:
a storing step of storing the second view-point video;
a video receiving step of receiving the first view-point video over the broadcast waves;
an information obtaining step of obtaining inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback;
a playback step of playing back the second view-point video; and
a control step of inhibiting the second view-point video from being played back when the scheduled presentation time of a next video frame, which is a video frame to be displayed next, is later than current time and the inhibition/permission information indicates that displaying the next video frame is inhibited.

8. A video playback program for causing a computer to function as a video playback device for performing a realtime playback of 3D video by playing back a first view-point video and a second view-point video in combination, the first view-point video being received via broadcasting in real time over broadcast waves, the second view-point video being stored in advance before the broadcasting of the first view-point video, the video playback program causing the computer to function as:
a storage storing the second view-point video;
a video receiving unit configured to receive the first view-point video over the broadcast waves;
an information obtaining unit configured to obtain inhibition/permission information that indicates, for each of a plurality of video frames, whether displaying a video frame before current time reaches a scheduled presentation time is inhibited or permitted, the scheduled presentation time being a time at which the video frame is scheduled to be broadcast for the realtime playback;
a playback unit configured to play back the second view-point video; and
a control unit configured to inhibit the second view-point video from being played back when the scheduled presentation time of a next video frame, which is a video frame to be displayed next, is later than current time and the inhibition/permission information indicates that displaying the next video frame is inhibited.

9. A video transmission device for transmitting a 3D video that is to be played back in real time by playing back a first view-point video and a second view-point video in combination, the video transmission device comprising:
a realtime transmission unit configured to broadcast the first view-point video in real time;
an advance transmission unit configured to transmit the second view-point video in advance before the first view-point video is broadcast in real time; and
an information transmission unit configured to transmit inhibition/permission information that indicates whether displaying a video frame before a scheduled presentation time is inhibited or permitted.

10. The video transmission device of claim 9, wherein
the information transmission unit transmits the inhibition/permission information over broadcast waves.

11. The video transmission device of claim 9, wherein
the inhibition/permission information transmitted by the information transmission unit contains information indicating date and time at which use of the inhibition/permission information is to be started.

12. The video transmission device of claim 9, wherein
the information transmission unit further transmits date-and-time information that indicates date and time at which the second view-point video is to be deleted.

13. The video transmission device of claim 9, wherein
each of a sequence of video frames constituting the first view-point video is assigned a scheduled display time that is set based on a first initial time,
each of a sequence of video frames constituting the second view-point video is assigned a scheduled display time that is set based on a second initial time that is different from the first initial time, and
the information transmission unit further transmits a difference time between the first initial time and the second initial time.

14. A video transmission method for use in a video transmission device for transmitting a 3D video that is to be played back in real time by playing back a first view-point video and a second view-point video in combination, the video transmission method comprising:
a realtime transmission step of broadcasting the first view-point video in real time;
an advance transmission step of transmitting the second view-point video in advance before the first view-point video is broadcast in real time; and
an information transmission step of transmitting inhibition/permission information that indicates whether displaying a video frame before a scheduled presentation time is inhibited or permitted.

15. A video transmission program for causing a computer to function as a device for transmitting a 3D video that is to be played back in real time by playing back a first view-point video and a second view-point video in combination, the video transmission program causing the computer to function as:
a realtime transmission unit configured to broadcast the first view-point video in real time;
an advance transmission unit configured to transmit the second view-point video in advance before the realtime transmission unit broadcasts the first view-point video in real time; and
an information transmission unit configured to transmit inhibition/permission information that indicates whether displaying a video frame before current time reaches a scheduled presentation time is inhibited or permitted.
